(19) United States
(12) Patent Application Publication
(10) Pub. No.: US 2006/0180647 A1
(43) Pub. Date: Aug. 17, 2006

(54) RFID applications

(76) Inventor: Scott Robert Hansen, Irvine, CA (US)

Correspondence Address: Scott R. Hansen, 19431 Sierra Santo Road, Irvine, CA, 92603, US

(21) Appl. No.: 11/056,554

(22) Filed: Feb. 11, 2005

(51) Int. Cl. G06F 17/00; G07B 15/02; G06F 7/08

(52) U.S. Cl. 235/375; 235/384; 235/381

(57) ABSTRACT

Applications of RFID technology include: RFID Tags on Automobiles in Parking Garages; RFID w/Toothbrushes; RFID Tags For Laundry Settings; RFID Tags Or Labels to Find a Mate; RFID To Identify The Value Of Coins; RFID Tags In The Doctors Office; RFID Tags Or Labels In Game Arcades; RFID With Prisoners; RFID Tags To Identify Soldiers; RFID Labels As Tags To Label Particular Components Of Aircraft or Other Structures; Car, Snowmobile, Boat, Etc. Ignition That Won't Start Without RFID Card; Car seats with RFID reader and memory; Air bags that adjust based on information on RFID; Car that keeps track of GPS info and knows whos driving based on RFID; RFID Smart Closet; Method of taking attendance; RFID on networked desks to monitor the location of individuals; Personal computer reads RFID to log you in and take you to favorite web page, load favorites list, etc.; RFID labels on Files; RFID address label versions of all label and sheet inventions; RFID sports tickets; Combination function invitation and RFID chip to allow admittance; Roll of tape with RFID built in; Schoolbus reads which kids getting on, keeps record; RFID on each car wheel; RFID key to operate common-area laundry; RFID to automatically adjust weights/treadmill settings in gym; RFID w/clothes measurements, save shelf space at store, get proper size; RFID keyring w/car information; Keep track of who's driving around neighborhood; RFID dental implant; RFID Thumbtack; RFID Doorstop; RFID identification of boats or ships at docks; RFID on cups w/specifics of favorite coffee drinks; RFID on bridges with RFID tanks on top of cars, to detect speeding; RFID on studs in a wall and RFID reader that acts as a stud finder; RFID tags or labels inside tires; RFID cards supplied with newspapers or magazines; RFID card that lights up a when the user reaches a particular location; RFID sports ticket w/automatic map generation to seat; RFID card to tell school cafeteria what lunch to prepare for particular student; student desk with slot to receive RFID card, desks on networks together, Central computing system can tell where any particular student is sitting at any given moment within the school; RFID readers on outdoor play equipment; Authentication of Expensive Items With RFID; Paintings or other art work with RFID label to be used to verify the number in a limited series; RFID on sports helmet or uniform; RFID chips in paint; RFID cards issued to airline passengers to identify type of drinks and meals for a particular passenger, etc.; Greeting Cards With RFID; Decorative Tiles With RFID Tags; RFID in Car Washes; and Adaptive Advertising Based on RFID Information.

### CROSS-REFERENCES TO RELATED APPLICATIONS

This utility patent application claims priority from U.S. Provisional Patent Application No. 60/544,081, filed Feb. 11, 2004 and entitled “RFID Applications,” which is incorporated by reference herein.

### FIELD OF THE INVENTION

The present application relates to applications of Radio Frequency Identification technology.

### BACKGROUND OF THE INVENTION

In recent years automatic identification procedures (Auto ID) have become very popular in many service industries, purchasing and distribution logistics, industry, manufacturing companies and material flow systems. Automatic identification procedures exist to provide information about people, animals, goods and products

RFID systems may be roughly grouped into four categories:
EAS (Electronic Article Surveillance) systems: Generally used in retail stores to sense the presence or absence of an item. Products are tagged and large antenna readers are placed at each exit of the store to detect unauthorized removal of the item.
Portable Data Capture systems: Characterized by the use of portable RFID readers, which enables this system to be used in variable settings.
Networked systems: Characterized by fixed position readers which are connected directly to a centralized information management system, while transponders are positioned on people or moveable items.
Positioning systems: Used for automated location identification of tagged items or vehicles.

The technical details of RFID systems—of which there are many variations—are detailed in the patent and other literature and are well-known in the art. A new form of radio-frequency identification (RFID) tags—silicon chips a few millimeters in diameter, that can transmit data to a receiver. Dubbed product emitting numbering identification (PENI) tags, they are cheaper to make than traditional RFID tags. With the newer PENI tags, the radio is embedded directly on the chip, driving the price down significantly.

Essentially RFID technology uses two chips, a microchip and a radio transmitter, in a package as small as 0.4 inches across to store price and other product information. In some embodiments of the PENI tag, all of the information on the tag can be updated every time the package was scanned.

An RFID label is identification label, as thin as paper, with an integrated chip and antenna for contact-free data transfer. A small RFID label affixed to virtually any object individually identifies the object using a unique, factory-programmed, unalterable code. The technology has become a primary player in automated data collection, identification, and analysis systems worldwide. In the past, high cost of components, immature technology, and inefficient methods of applying the technology have limited the commercial use of these system.

Smart labels contain a paper thin RFID tag, sandwiched between a paper or plastic laminate, to provide a durable, low cost ‘electronic label’ with integral read/write memory. These smart labels have the same characteristics as RFID tags (for brevity, ‘RFID tag’ is used synonymously in the text that follows to mean both tag and smart label).

Smart labels are ultra thin RFID tags that are small and thin enough to be laminated between layers of paper or plastic, to produce low cost, consumable labels, stickers, tickets and documents, with an integral read/write memory. They are destined to revolutionize many commercial operations. Smart labels have all the benefits of RFID tags, but are flexible and of low enough cost to be disposable.

Smart labels effectively combine the advantages of existing barcode, RFID and Electronic Article Surveillance (EAS) technologies. Like RFID tags, smart labels can store information dynamically, without contact or line of sight. Such labels are almost indistinguishable from conventional paper labels widely used to support bar codes and other visible markings. However, these new labels provide the ability to carry information that may be changed at any time—providing a secure electronic “database” on individual labels. For the first time, it thus becomes possible, for example, to use smart labels on packaging, such that a label placed within a sealed carton may be read, and new information added or deleted at any time, with a range of security features to maintain data integrity. This can even take place when many labels are in close proximity—such as airline luggage sortation systems, or parcels and mail on a conveyor belt.

The following are a few of the multitude of patents issued on RFID technology:

U.S. Pat. No. 6,647,497 Method and system for secure computer system transfer

U.S. Pat. No. 6,271,793 Radio frequency (RF) transponder (Tag) with composite antenna

U.S. Pat. No. 6,263,440 Tracking and protection of display monitors by reporting their identity

U.S. Pat. No. 6,177,860 Method and economical direct connected apparatus for deploying and tracking computers

U.S. Pat. No. 6,170,059 Tracking memory modules within a computer system

U.S. Pat No. 6,154,790 Monitoring and reporting hard disk drives identification using radio frequency

U.S. Pat. No. 5,874,724 Light selectable radio frequency identification tag and method therefor

U.S. Pat. No. 5,822,714 Data processing system and method for accessing a plurality of radio frequency identification

There are many companies that work with RFID technology. Some of the many companies include Alanco Technologies, Technology Systems International, Axcess International, Checkpoint Systems, Escort Memory Systems, HEI, Inc., Hypercom Corp., Indala, Intermec Technologies Corp., Omron Semiconductors, samsys, Symbol Technologies, Tegal Corp., Texas Instruments, Tyco Fire & Security, and Zebra Technologies.

A non-limiting glossary of RFID terminology is as follows:

Active tag: An RFID tag that comes with a battery that is used to power the microchip's circuitry and transmit a signal to a reader.

Amplitude: The maximum absolute value of a periodic curve measured along its vertical axis (the height of a wave, in layman's terms).

Antenna: The antenna is the conductive element that enables the tag to send and receive data. Passive tags usually have a coiled antenna that couples with the coiled antenna of the reader to form a magnetic field. The tag draws power from this field.

Anti-collision: A general term used to cover methods of preventing radio waves from one device from interfering with radio waves from another. Anti-collision algorithms are also used to read more than one tag in the same reader's field.

Auto-ID Center: A non-profit collaboration between private companies and academia that is pioneering the development of an Internet-like infrastructure for tracking goods globally through the use of RFID tags.

Automatic Identification: Sometimes called automatic data capture. These are methods of collecting data and entering it directly into computer systems without human involvement. Technologies normally considered part of auto-id include bar codes, biometrics, RFID and voice recognition.

Back scatter: A method of communication between tags and readers. RFID tags using back-scatter technology reflect back to the reader a portion of the radio waves that reach them. The reflected signal is modulated to transmit data. Tags using back scatter technology can be either passive or active, but either way, they are more expensive than tags that use inductive coupling.

Bar code: A standard method of identifying the manufacturer and product category of a particular item. The barcode was adopted in the 1970s because the bars were easier for machines to read than optical characters. Barcodes' main drawbacks are they don't identify unique items and scanners have to have line of sight to read them.

Contactless smart card: An awkward name for a credit card or loyalty card that contains an RFID chip to transmit information to a reader without having to be swiped through a reader. Such cards can speed checkout, providing consumers with more convenience.

Chipless RFID tag: An RFID tag that doesn't depend on an integrate microchip. Instead, the tag uses materials that reflect back a portion of the radio waves beamed at them. A computer takes a snapshot of the waves beamed back and uses it like a fingerprint to identify the object with the tag. Companies are experimenting with embedding RF reflecting fibers in paper to prevent unauthorized photocopying of certain documents. But chipless tags are not useful in the supply chain, because even though they are inexpensive, they can't communicate a unique serial number that can be stored in a database.

Closed-loop systems: RFID tracking systems set up within a company. Since the tracked item never leaves the company's control, it does not need to worry about using technology based on open standards.

Die: The silicon block onto which circuits have been etched.

EEPROM (Electrically Erasable Programmable Read-Only Memory): A non-volatile storage device on microchips. Usually bytes can be erased and reprogrammed individually. RFID tags that use EEPROM are more expensive than factory programmed tags, but they offer more flexibility because the end user can write an ID number to the tag at the time the tag is going to be used.

Electromagnetic compatibility (EMC): The ability of a system or product to function properly in environment where other electromagnetic devices are used and not be a source itself of electromagnetic interference.

Electromagnetic interferance (EMI): Interference caused when the radio waves of one device distort the waves of another. Cells phones, wireless computers and even robots in factories can produce radio waves that interfere with RFID tags.

Electronic article surveillance (EAS): Simple electronic tags that can be turned on or off. When an item is purchased (or borrowed from a library), the tag is turned off. When someone passes a gate area holding an item with a tag that hasn't been turned off, an alarm sounds. EAS tags are embedded in the packaging of most pharmaceuticals.

Electronic Product Code: (EPC): A 96-bit code, created by the Auto-ID Center, that will one day replace barcodes. The EPC has digits to identify the manufacturer, product category and the individual item. It is backed by the United Code Council and EAN International, the two main bodies that oversee barcode standards.

Error correcting code: A code stored on an RFID tag to enable the reader to figure out the value of missing or garbled bits of data. It's needed because a reader might misinterpret some data from the tag and think a Rolex watch is actually a pair of socks.

Error correcting mode: A mode of data transmission between the tag and reader in which errors or missing data is automatically corrected.

Error correcting protocol: A set of rules used by readers to interpret data correctly from the tag.

European Article Numbering (EAN): The bar code standard used throughout Europe, Asia and South America. It is administered by EAN International.

Excite: The reader is said to “excite” a passive tag when the reader transmits RF energy to wake up the tag and enable it to transmit back.

EXtensible markup language (XML): A widely accepted way of sharing information over the Internet in a way that computers can use, regardless of their operating system.

Factory programming: Some read-only have to have their identification number written into the silicon microchip at the time the chip is made. The process of writing the number into the chip is called factory programming.

Field programming: Tags that use EEPROM, or non-volatile memory, can be programmed after it is shipped from the factory.

Fluidic Self-Assembly: A manufacturing process, patented by Alien Technology. It involves flowing tiny microchips in a special fluid over a base with holes shaped to catch the chips.

Frequency: The number of repetitions of a complete wave within one second. 1 Hz equals one complete waveform in one second. 1 KHz equals 1,000 waves in a second. RFID tags use low, high, ultra-high and microwave frequencies. Each frequency has advantages and disadvantages that make them more suitable for some applications than for others.

GTAG (Global Tag): A standardization initiative of the Uniform Code Council (UCC) and the European Article Numbering Association (EAN) for asset tracking and logistics based on radio frequency identification (RFID). The GTAG initiative is supported by Philips Semiconductors, Intermec, and Gemplus, three major RFID tag makers.

High-frequency tags: They typically operate at 13.56 MHz. They can be read from about 10 feet away and transmit data faster. But they are consume more power than low-frequency tags.

Inductive coupling: A method of transmitting data between tags and readers in which the antenna from the reader picks up changes in the tag's antenna.

Industrial, Scientific, and Medical (ISM) bands: A group of unlicensed frequencies of the electromagnetic spectrum.

Integrated circuit (IC): A microelectronic semiconductor device comprising many interconnected transistors and other components. Most RFID tags have ICs.

Interrogator: See RFID reader.

Low-frequency tags: They typically operate at 125 KHz. The main disadvantages of low-frequency tags are they have to be read from within three feet and the rate of data transfer is slow. But they are less expensive and less subject to interference than high-frequency tags.

Memory: The amount of data that can be stored on a tag.

Microwave tags: Radio frequency tags that operate at 5.8 GHz. They have very high transfer rates and can be read from as far as 30 feet away, but they use a lot of power and are expensive.

Modulation: Changing the frequency or amplitude of a wave to transmit data that is converted into digital form. For example, a wave with the normal amplitude (or height) may be a one in binary code and a wave with a lower amplitude might be a zero.

Multiple access schemes: Methods of increasing the amount of data that can be transmitted wirelessly within the same frequency spectrum. RFID readers use Time Division Multiple Access, or TDMA, meaning they read tags at different times to avoid interfering with one another.

Multiplexer: An electronic device that allows a reader to have more than one antenna. Each antenna scans the field in a preset order.

NanoBlock: The term Alien Technology uses to describe its tiny microchips, which are about the width of three human hairs.

Nominal range: The read range at which the tag can be read reliably.

Null spot: Area in the reader field that doesn't receive radio waves. This is essentially the reader's blind spot. It is a phenomenon common to UHF systems.

Object Name Service (ONS): An Auto-ID Center-designed system for looking up unique Electronic Product Codes and pointing computers to information about the item associated with the code. ONS is similar to the Domain Name Service, which points computers to sites on the Internet.

Passive tag: An RFID tag without a battery. When radio waves from the reader reach the chip's antenna, it creates a magnetic field. The tag draws power from the field and is able to send back information stored on the chip. Today, simple passive tags cost around 50 cents to several dollars.

Patch antenna: A small square antenna made from a solid piece of metal or foil.

Physical Markup Language (PML): An Auto-ID Center-designed method of describing products in a way computers can understand. PML is based on the widely accepted eXtensible Markup Language used to share data over the Internet in a format all computers can use.

PML Server: A server that responds to requests for Physical Markup Language (PML) files related to individual Electronic Product Codes. The PML files and servers will be maintained by the manufacturer of the item.

Power level: The amount of RF energy radiated from a reader or an active tag. The higher the power output, the longer the read range, but most governments regulate power levels to avoid interference with other devices.

Programming: Writing data to an RFID tag.

Proximity sensor: A device that detects the presence of an object and signals another device. Proximity sensors are often used on manufacturing lines to alert robots or routing devices on a conveyor to the presence of an object.

Radio Frequency Identification (RFID): A method of identifying unique items using radio waves. Typically, a reader communicates with a tag, which holds digital information in a microchip. But there are chipless forms of RFID tags that use material to reflect back a portion of the radio waves beamed at them.

Read: The process of turning radio waves from a tag into bits of information that can be used by computer systems.

Read rate: The maximum rate at which data can be read from a tag expressed in bits or bytes per second.

Reader (also called an interrogator): The reader communicates with the RFID tag via radio waves and passes the information in digital form to a computer system.

Reader field: The area of coverage. Tags outside the reader field do not receive radio waves and can't be read.

Read-only tags: Tags that contain data that cannot be changed unless the microchip is reprogrammed electronically.

Read range: The distance from which a reader can communicate with a tag. Active tags have a longer read range than passive tags because they use a battery to transmit signals to the reader. With passive tags, the read range is influenced by frequency, reader output power, antenna design, and method of powering up the tag. Low frequency tags use inductive coupling (see above), which requires the tag to be within a few feet of the reader.

Read-write tags: RFID tags that can store new information on its microchip. San Francisco International Airport uses a read-write tag for security. When a bag is scanned for explosives, the information on the tag is changed to indicate it has been checked. The tag is scanned again before it is loaded on a plane. Read-write tags are more expensive than read only tags, and therefore are of limited use for supply chain tracking.

RFID tag: A microchip attached to an antenna that picks up signals from and sends signals to a reader. The tag contains a unique serial number, but may have other information, such as a customers' account number. Tags come in many forms, such smart labels that are stuck on boxes; smart cards and key-chain wands for paying for things; and a box that you stick on your windshield to enable you to pay tolls without stopping. RFID tags can be active tags, passive tags and semi-passive tags.

Scanner: An electronic device that can send and receive radio waves. When combined with a digital signal processor that turns the waves into bits of information, the scanner is called a reader or interrogator.

Semi-passive tag: Similar to active tags, but the battery is used to run the microchip's circuitry but not to communicate with the reader. Some semi-passive tags sleep until they are woken up by a signal from the reader, which conserves battery life. Semi-passive tags cost a dollar or more.

Sensor: A device that responds to a physical stimulus and produces an electronic signal. Sensors are increasingly being combined with RFID tags to detect the presence of a stimulus at an identifiable location.

Silent Commerce: This term covers all business solutions enabled by tagging, tracking, sensing and other technologies, including RFJD, which make everyday objects intelligent and interactive. When combined with continuous and pervasive Internet connectivity, they form a new infrastructure that enables companies to collect data and deliver services without human interaction.

Smart label: A label that contains an RFID tag. It's considered “smart” because it can store information, such as a unique serial number, and communicate with a reader.

Time Division Multiple Access (TDMA): A method of solving the problem of the signals of two readers colliding. Algorithms are used to make sure the readers attempt to read tags at different times.

Transponder: A radio transmitter-receiver that is activated when it receives a predetermined signal. RFID tags are sometimes referred to as transponders.

Ultra-high frequency (UHF): Typically, tags that operate between 866 MHz to 930 MHz. They can send information faster and farther than high- and low-frequency tags. But radio waves don't pass through items with high water content, such as fruit, at these frequencies. UHF tags are also more expensive than low-frequency tags, and they use more power.

UHF tags may have advantages of small size and very fast data transfer properties. UHF offers two key features that will enable the benefits of RFID to be used in many more applications than were feasible in the past: (1) Read Range: UHF tags can deliver up to ten times or more greater read range than an equivalent HF tag. In the USA, UHF RFID systems are frequently demonstrated reading tags at distances of 10 m or more. (2) “Anti collision” properties: refer to the ability of tags to be read efficiently when they are presented to a reader in dense groups. For example, if we were to take a tote box containing 20 loosely packed items and tag each of these items with a HF tag, it is unlikely that we would then be able to pass that tote box through a MultiScanner and be able to read each tag. The reason being that if HF tags come into close proximity to each other, they may, in some systems, become difficult to read. UHF tags by contrast can be presented to a reader in far greater densities. If we were to place UHF tags on each of these 20 items in a tote box, then this box could be received into a warehouse (for example) automatically, with each item being read speedily and accurately. It is this property of UHF RFID that makes this technology ideal for item level applications such as garment tagging in a retail environment.

Uniform Code Council (UCC): The nonprofit organization that overseas the Uniform Product Code, the barcode standard used in North America.

Uniform Product Code (UPC): The barcode standard used in North America. It is administered by the Uniform Code Council.

Write rate: The rate at which information is transferred to a tag, written into the tag's memory and verified as being correct.

XML Query Language (XQL): A method of querying a database based on XML. Files created using the Auto-ID Center's Physical Markup Language can be searched using XQL.

### SUMMARY OF THE INVENTION

Broadly speaking, the invention relates to specific applications of RFID technology. For example, applications of RFID technology that fall within the scope of the invention include parking garages that read RFID tags on automobiles parked therein, with a centralized computer system to identify and monitor the various automobiles parked therein; toothbrushes with RFID devices; RFID tags on clothing that determine laundry settings, which may be used in conjunction with washers and/or dryers that have RFID readers; RFID tags, labels, cards, namebadges or the like with information thereon that can help in mate-finding activities, such as social mixers for singles; using RFID technology to identify the value of money; various uses of RFID devices in a doctor's office; use of RFID in game arcades; using RFID in conjunction with prisoner identification and handling; using RFID tags to identify soldiers; using RFID labels or tags to label particular components of aircraft or other structures; a car, snowmobile, boat, or other ignition that won't start without an RFID card, tag or other device; car seats with an RFID reader and optionally memory; and air bags that adjust based on information on passenger-carried RFID.

Additional applications within the scope of the invention include a car that keeps track of GPS info and knows who is driving the car based on an RFID device associated with the driver; an RFID smart closet; a method of taking attendance based on reading student RFID information; RFID on networked desks to monitor the location of students; a personal computer that reads RFID information to log you in and take you to favorite web page, load favorites list, etc.; RFID labels on files; RFID-based sports tickets, optionally used in conjunction with a system that displays a seat map or other information upon reading the RFID ticket; a combination invitation and RFID device that allows admittance to an event; a roll of tape with RFID built in; a school bus that reads which kids are getting on, keeps records; RFID devices provided on each car wheel; an RFID key to operate common-area laundry; RFID to automatically adjust weights/treadmill settings in a gym; encoding an RFID device with a person's clothes measurements, in order to save shelf space at a store and/or to identify garments that will fit the individual; an RFID key ring w/car information; using RFID information to keep track of who is driving around a neighborhood; RFID dental implants; thumbtacks incorporating an RFID device; and doorstops encoded with RFID information.

Still further applications within the scope of the invention include RFID identification of boats or ships at docks; RFID on cups w/specifics of favorite coffee drinks; RFID readers on bridges with RFID tags on cars, to detect speeding; RFID devices on studs in a wall and a hand-held RFID reader that acts as a stud finder; RFID tags or labels inside tires; RFID cards supplied with newspapers or magazines; an RFID card that lights up a when the user reaches a particular location; an RFID card to tell a school cafeteria what lunch to prepare for particular student; a student desk with a slot to receive an RFID card, with the desks optionally being on a network together, and in which a central computing system can tell where any particular student is sitting at any given moment within the school; RFID readers on outdoor play equipment; authentication of expensive items with RFID; paintings or other art work with RFID label to be used to verify the number in a limited series; RFID on a sports helmet or uniform; RFID chips in paint, with the paint being applicable to a surface with a sprayer or brush; RFID cards issued to airline passengers to identify type of drinks and meals for a particular passenger, etc.; greeting cards With RFID information affixed or incorporated thereto; decorative tiles with RFID tags; RFID to control variables in car washes; and adaptive advertising based on RFID information read from one or more individuals.

One specific embodiment of the invention relates to using RFID information in the environment of a car wash. In one embodiment, a method relates to washing an automobile in a car wash, with the automobile or an occupant therein having an RFID tag, label or device on which is stored information such as the make, model, year, paint color, type of paint, and/or other information. The method may include steps of reading information on the RFID device, adjusting car wash variables based on information on the RFID device, and washing the automobile. The car wash variables may include the pre-soak time and/or chemicals used in pre-soak, time of wash, type of chemicals used in the wash, mix ratio of a chemical cleaner, amount of soap, amount of wax, type of wax, number of wash cycles, drying time, drying temperature, use of a chemical to enhance the color of the car, speed of the scrubbers, water jet pressure, rinse time, type of scent, and vacuum pressure, among other possible variables.

Information on the RFID tag, label or device may include the make, model, year, color, at least one car dimension, wash history, date of last wash, conditions under which the car is driven, conditions under which the car is stored, vehicle identification number, license plate number, car wash instructions, car wash settings, paint type, tire size, payment information and coating type, among other things.

In one embodiment, the step of adjusting car wash settings includes sending information to a digital control system, which controls various functions of the car wash. Other embodiments may include providing instructions or other information to a post-wash worker based on information read from the RFID device. Information read from the RFID device may also be used to obtain further information from a database. The further information from the database may be used to control aspects of the car wash process.

### BRIEF DESCRIPTION OF THE DRAWINGS

FIG. 1 is a flow chart illustrating the steps in one embodiment of the invention;

FIG. 2 is a flow chart illustrating the steps in another embodiment of the invention; and

FIG. 3 is a block diagram showing components in one embodiment of the invention.

### DETAILED DESCRIPTION OF THE INVENTION

Application No. 1: Using RFID Tags on Automobiles in Parking Garages

An RFID tag or label is located on an automobile. One example of an RFID label for use on an automobile windshield is the “915 MHz Windshield Sticker Tag by Intermec. The RFID tag or label may include the digital information that identifies the car, such as the vehicle identification number or license plate number. A parking garage has numerous parking spaces, with a network of RFID readers throughout the garage. In one embodiment, there is one RFID reader dedicated to a single parking space, although many variations of this are possible.

When a car pulls into the parking space, the RFID reader reads the information on the RFID tag or label that is on the automobile. The reader then sends the information to a central computing system, which correlates the parking space number within the vehicle that is parked in parking space. The computing system may also, for example, obtain further information from an internal or external network about the vehicle based on the vehicle identification number. So, for example, the central computing system may be able to determine the make, model, and year of every car parked in every space in the garage. Alternatively, the system may also identify the owner of each car, whether the registration fees are currently paid on the car, and a vast variety of other information.

Associated with a computer system may be various features, such as a timer to which keeps track of the length of time each vehicle has parked in a particular parking space. If there is a time limit for parking within a particular parking space, the system can raise a red flag or warning to a central operator to indicate that the car has overstated the time limit. Parking patrol officers may be notified either manually or automatically of cars that have overstayed the time limit in a particular parking space. There are a great many other operations that can be performed by the central computing system, such as keeping daily logs of all vehicles that have parked within the structure, which may be useful for law enforcement and other applications.

The central computer system may automatically generate tickets for cars that have parked in a space too long, or for cars that have expired registrations, or issue alerts to police or security personnel if the system determines that a particular car is stolen (in which case the central computer system would have access to a database of information to identify stolen cars) or is a car for which authorities are looking for some other reason (in which case the central computer system would have access to a database identifying cars for which authorities are looking).

In another embodiment, the RFID tag or label is readable/writable. Rather than sending information from the tag or label to a central computer system, the RFID scanner writes information onto the tag or label, such as the time and date of entry into the parking garage. Alternatively, a security person may write onto the tag as he or she makes her rounds.

In another embodiment, a parking space has a parking meter. The user swipes an RFID tag across a reader on the parking meter. The parking meter then reads the RFID tag, identifies the person swiping the tag, and charges a user account for the time the user parks in that space. In one embodiment, the user again swipes the RFID tag across the parking meter to let it know that the user has returned and is pulling out of the parking space.

Considering another aspect, the RFID tag or label may be located at any of the number of different locations on or in the automobile. For example, the RFID tag or label may be located on the front grill of the automobile with the RFID reader correlating to the parking space being located at an area directly in front of what would be the car grill. As discussed above, the RFID readers would typically be hooked to a network, such that each RFID reader communicates to a central data collection system of some sort. The RFID readers may be networked together, or may operate as stand-alone readers, depending on the desired configuration.

Application No. 2: Using RFID to Distinguish Between Different Toothbrushes

It is a common problem in households that people forget which toothbrush belongs to which person. Consequently, the toothbrush may be provided with an RFID tag that gives the toothbrush a unique identifier. To determine the owner of the toothbrush, the user may scan the toothbrush with an RFID scanner that may have, for example a display or other output mechanism. In the RFID reader may be associated with memory/database in which is stored a correlation between the RFID number of the toothbrush and the name of particular user. That way, when the user scans of the toothbrush across the scanner the name of the person with which the toothbrush is associated appears on the screen.

Application No. 3: Using RFID Tags For Laundry Settings

RFID tags are sewn or otherwise attached to clothing. An RFID associated with a washing machine reads the RFID tags, which are encoded with instructions as to how the garment is to be cleaned. Washing machine variables (water temperature, delicate or other cycle, rinse temperature, wash time, number of rinses, etc.) are set based on information read on the tags. In the event that information on different items of clothing conflict (e.g. some clothes specify cold wash only while others indicate hot water wash), the machine may go into a default mode (e.g. warm water wash), or may sound an alarm or otherwise indicate to the operator (e.g. by message on a display screen or buzzer or the like) that an incompatibility exists.

In some embodiments, the washing machine may be custom-set to clean clothes in a way that is more precise than current manually-selected wash variables. That is, rather than merely choosing between cold, warm or hot water wash, the RFID tags may specify specific water temperatures to be used. In the case of conflicting water temperature information on different tag, a computer aboard the washing machine can be programmed to take an average temperature, or to use the lowest temperature, or to implement any other algorithm desired by the manufacturer or the user.

Numerous microcontrollers are incorporated into modern washing machine design. With the addition of RFID information on clothing, a database may be added in some embodiments to correlate RFID information from the clothing to instructions to the washing machine. Memory modules, additional microcontrollers, and other components may be added to the electronic design, depending on the particular embodiment desired.

Prior art clothes dryers used few electronic controls. More modern clothes dryers now use electronic systems to detect moisture level and respond accordingly, to control various components of the dryer and, especially, to control the level of heat, to adjust cool-down periods, and to determine the time at which the drying should stop. With the addition of RFID information on clothing, a database may be added in some embodiments to correlate RFID information from the clothing to instructions to the dryer. Memory modules, additional microcontrollers, and other components may be added to the electronic design, depending on the particular embodiment desired.

Application No. 4: Using RFID Tags or Labels For a Person Looking For a Mate

Millions of people throughout the United States or are looking for a mate of the opposite or same-sex. It is not uncommon on the World Wide Web, for example, for users to include a great deal of information about themselves and then run a database search to find compatible potential partners. In this application, RFID tags are labels are prepared with information about the particular person who is wearing the RFID tag. For example, the information may include height and weight, eye color, date of birth, number of children, marital status, information about the person's sexual preferences, information about the type of partner that person is looking for, and/or a variety of other information that might be useful in matching to people together.

In one method, a singles party is held in which each attendee wears an RFID tag containing various information about him or herself and about what that person is looking for in a potential mate. As party attendees mingle through the crowd, each is provided with an RFID scanner with a display screen or other type of output device. Each person may then a scan the RFID tag of someone in proximity, in order to find out more about that person and what they are looking for.

In another embodiment, attendees walk through a scanner that scans the information on the RFID tag. The information is then sent to a central computer system, and automatically matches potential partners based upon preferences and other information that has been stored on the RFID tag. Lists may then be printed out from the central computer system and distributed to each attendee, as desired, and then the attendees may spend time with the any of the people listed on the customized computer printout lists. Or messages may be sent to user's cell phones, to hand-held text messaging units, or any of a wide variety of information receiving devices. In this way the social gatherings for finding mates are made more efficient.

Application No. 5: Using RFID to Identify the Value of Coins

In this application, standard monetary coins and/or game tokens are provided with RFID tags, such as quarters, nickles, dimes, pennies, dollars, tokens and so on. In addition to each coin having a unique size, each coin is provided with an RFID mechanism within the coin. Coin-accepting machines, such as vending machines, would utilize not only the size and weight information of the coin to determine whether a coin is real, as opposed to being a slug, and would included an RFID reader to read specific RFID information off the coin. The information stored in the RFID chip on the coin would identify the coin as being valid.

The information could include specific identifying numbers from the official government agency that makes the coin, and may even provide a unique coin identifier that identifies the coin specifically as opposed to all other coins. In one embodiment, the RFID mechanism is located on the interior of the coin (e.g. embedded within the coin), so that it would not be disturbed as the coin is used over and over again in commerce.

Application No. 6: Using RFID Tags in the Doctors Office

In some physical examination contexts, such as for examining military inductees, a large number of patients are examined in a fairly short period of time. To provide each of the health-care professionals with instant information about a particular individual, each individual may be supplied with and RFID tag or label that includes information about that particular person, such as their name, date of birth, heights, weight, rank, blood type, and various other information that may be useful during physical examination. In this way, the health-care professionals who use an RFID reader can instantly read the information about a particular patient. A data system may be provided such that when an RFID tag or label associated with a particular patient is read with an RFID scanner, medical records about that particular person are then called up from a database and displayed on a display device, such as a screen. In this way, much paperwork is eliminated and paper files are not needed throughout the examination process.

Application No. 7: Using RFID Tags or Labels in Game Arcades

In this application, each patron in a game arcade, such as an arcade where video and other types of games are played, is provided with an RFID label or tag. Person purchases a particular amount of game usage credits. The amount that the user has purchased it is entered into a database. The various games within the arcade are networked together. Each game machine may include an RFID scanner, or scanners may be strategically located in the arcade at predetermined positions.

When a particular user goes to play the game, a scanner scans the RFID tag of the user and sends that information to a central computer system. The central computer system processes the data and sends back information to the game as to whether or not the user has sufficient credit to play the game. Alternatively, the system can simply send back a signal to the game, turning the game on or off for that particular individual. Consequently, as an individual has sufficient credit on his or her account, he or she can continue to play games. But, when the user has used up his or her credits, the central computer system signals the machine that the user is not authorized to play the game, or is limited to playing the game in a limited mode.

The system may also be used in situations where particular games are restricted to particular people. For example, adult games may be restricted to people who are 18 years old or older. At the time of credit purchase, the user may be required to show identification of the user's age. In that case, someone who is 18 years or older may be issued an RFID tag indicating that that person is sufficiently old to play I games for people who are 18 years or older. Then once such a user approaches the game, the RFID scanner on the machine scans the data and transmits it to a central computer system, which then verifies that particular user is authorized to play that particular game, whereupon the game begins. However for someone who is underaged, the central computer system would send back to signal to the game which does not authorize the game to start up and therefore the underage individual is unable to play the game.

Many variations on this can be imagined, and the implementation may be done in a variety of different ways. However it is likely that any such system would include games that are networked together in some fashion, a central database, said includes user information, and RFID tags containing data that correlates a particular game player with information about that game player.

Furthermore, in some arcades, games may be played in which the location of the user within a particular area becomes important, such as in Laser Tag. RFID readers located within the Laser Tag game room monitor the location of the players within the game room. Games can be played in which limited location information is provided to certain players under certain conditions, as when a particular point goal is achieved, the location of opponents is briefly provided, etc. The idea of using RFID-derived location information can be used to create a large variety of different games.

As an alternative to systems using a centralized computer system, a re-writable RFID tag may be used, in which information such as the total play credits remaining for the user are constantly updated by RFID scanners as the user plays games. Information as to the user's age and/or other information may simply be written to the tag, rather than being stored in a centralized database.

Application No. 8.: Using RFID With Prisoners

Each prisoner in the penitentiary is provided with an RFID tag or label. The tag or label.may be provided in the form of a wristband for example or in some other item that is not easily removed from the body. As a prisoner moves throughout the prison, RFID scanners scan the RFID tags or labels so that a central computer system monitors the location and movement of the various prisoners within the prison. Locks may unlock when a particular approved prisoner approaches, or may remain locked for unapproved prisoners. The RFID tag or label may be provided in the form of an unremovable wrist or ankle band, as one example. The system may be used in conjunction with a centralized database or, alternatively, sufficient memory may be provided on the RFID tag to store the desired information. The tag may be re-writable, so that information about the prisoner, his activities, whereabouts, and so on may be updated in real time.

Application No. 9: Using RFID Tags to Identify Soldiers

Currently, soldiers serving in combat are identified by what are known as “dog tags”. These are metal tags that are imprinted with particular information about the soldier. However, the dog tag may be devised that includes an RFID chip. The dog tag may include printed information about the soldier that an enemy may need to know in the event that the soldiers captured. For example the printed information may include name rank and serial number. However additional data may be programmed onto the RFID portion of the tag, which may be in the form of the label that is attached to the back of the tag, or the tag may just simply be a fairly thick with the RFID portion stored within the tag.

The information on the RFID tags will typically be coded. Consequently, when an enemy captures the soldier, the enemy is not able to determine the meaning of the RFID information it is stored on the RFID tag. However the enemy can read the information that is printed on the dog tag, such as the name rank and serial number of the soldier. A member of the soldier's own unit, however, using RFID scanner with a related database to correlate the encoded information on the RFID tag with specific information, may be able to gather much more information about the soldier by scanning the tag with the RFID scanner. For example, the soldiers medical history, service history, and unit number, the date of arrival in country, and much other information may be stored on the RFID portion of the dog tag.

Or, a unique identifier and number may simply be propelled provided to the RFID portion. Then, when using the scanner in communication with a centralized computer database, the user may be able to call up records or other information about that particular soldier that have been correlated in the database between the number on the RFID tag on the one hand and information that has been input into the database about that soldier, his or her unit, and so on, on the other hand.

This duel-function the dog tag can be particularly useful in situations where the limited information now available on dog tags simply is not enough. The RFID dog tanks may be used, for example, during physical examinations, when a doctor or other health-care professional may scan the dog tag with an RFID scanner to pull up medical records of the soldier wearing the dog tanks.

Application No. 10: Using RFID Labels as Tags to Label Particular Components of Aircraft or Other Structures

Currently when there's an aircraft crash and the aircraft is destroyed, as very occasionally happens with commercial jetliners, specialists are entrusted with the duty of reconstructing the plane to the best of their ability. However, one problem that is often encountered is determining which of the many recovered parts belongs in the particular location when reconstructing the aircraft. In this application, each structural member of an aircraft is provided with an RFID tag. The RFID tag or label correlates the particular structural member with a particular number. Stored in a database in a computer system is a correlation between the RFID number on a particular components of the aircraft and in the specific location of that component on the aircraft.

So, for example, on the structure there may be many structural members. However, each structural member is provided with an RFID tag or label giving it a unique identifier. When the plane crashes and breaks into many pieces, perhaps scattered over a wide area, once those that structural pieces are recovered, a reconstruction specialist can use an RFID scanner in conjunction with a database into which a correlation between the RFID number and the structural part and location is stored. In this way, the reconstruction expert is able to quickly determine where on the aircraft a particular recovered part comes from.

This RFID labeling of various structural components of an aircraft adds minimal weight to the aircraft or other structure. Furthermore, the RFID labeling of particular structural members will also be useful when the aircraft is being repaired. For example, if it is known that a particular structural member needs to be repaired, a technician can find that structural member fairly easily using an RFID scanner and scanning various structural components of the aircraft until he or she finds the particular structural components that he or she needs to repair or replace.

It should be noted that the particular method described herein is not limited to aircraft. Any structure with multiple structural components may be identified using RFID tags or labels. These structures may include a wide variety of structures, including ships, trains, automobiles, houses, buildings, furniture, puzzle pieces, and many other applications.

Application No. 11: Car, Snowmobile, Boat, Etc. Ignition That Won't Start Without RFID Card

As background, many cars manufactured by GM come with a security feature called the PASS-Key theft deterrent system. You can tell if a car has this feature by looking at the ignition key—the key's shaft has a small black module embedded in it with contacts on either side of the key. It is common to assume that there is some sort of chip or computer embedded in the key.

It turns out the system is a lot simpler than that, but still effective. What is embedded in the key is one precision resistor. When you insert the key in the ignition, the resistor becomes part of a simple circuit involving three other resistors. If the key does not have a resistor or if the resistor has the wrong value, the circuit disables part of the car's electrical system to prevent the car from starting.

So why is this system using something as mundane as a single resistor rather than some sort of sophisticated embedded computer? There are probably two reasons: 1) manufacturing cost, and 2) reliability. The latter is probably a very big part of the equation. Think about everything a key goes through—it's typically riding in a pocket full of coins, getting thrown on the table, opening bottles, and so on. Keys have to be remarkably durable, they have to last the life of the car, and they must always work. If a system that depends on a single resistor can do a good job, then that's a good system to use because there is less that can go wrong.

However, with RFID, the system can be made more sophisticated. A car, snowmobile, or other type of vehicle will not start unless a proper RFID tag or label is detected. The tag or label may be in the form of a unit on a key ring, or maybe implanted in the driver's bodyand, for example, the car, snowmobile or other type of vehicle is equipped with and RFID reader, which may be adjacent to the key insert for starting the ignition. Alternatively, the RFID reader could be underneath the seat, on the dashboard, or elsewhere within the vehicle.

The RFID scanner would send a signal to a microprocessor based system when the proper RFID code is read from the RFID tag or label. Once the microprocessor receives the signal from the RFID scanner, the microprocessor unlocks an electronic lock that allows the ignition to start. Other means of implementing the system will be known to those skilled in the art of electronics.

In addition to An RFID reader, there may be provided memory so that a record is kept of the particular people who are driving the car. There may be database system on board the car, such that a record of the particular driver, and the date and time that the driver was driving the car is stored. This information may be stored locally on the car, or may be transmitted to a remote location where the information is kept and or processed.

The RFID tag may be re-writable, such that a record is stored on the RFID tag of when the vehicle was started and stopped over a period of time. Other information, such as vehicle performance information (such as maximum speed reached on a trip, any mechanical or electrical problems encountered with the vehicle, and the like) can be written to the RFID tag on trips. The RFID tag may be used in conjunction with a small GPS system such that roadside assistance is automatically called upon a vehicle malfimction.

Application No. 12: Car seats with RFID reader and memory to keep track of who's in Car

An automobile is provided with one or a plurality of RFID readers on the interior of the car. In one embodiment, the reader(s) are placed underneath a/the seats of the car. As an individual sits down in the car, an RFID reader reads the RFID chip that is placed either in the users wallet in the form for card, or a chip that is implanted in the users body, or a chip that the user's wearing as jewelry, or any of a variety of other possible modes of associating an RFID tag or label with a particular user.

The RFID scanners may be linked together in a network and/or communicate with a central data processing system. Information that the scanner reads from the RFID chips is then transmitted through the network or correctly to a central data processing unit. Information on the RFID tags are labels may include user identification information and/or other information. In one embodiment, the RFID tag or label or implant stores information about the user. Consequently, the RFID reader reads the information about the user and transmits it to the central data system, which keeps a database for record of the identity of various passengers within the car at a given time and their location within the car. This might be useful, as for example, when rental cars wish to keep track of who is driving an automobile during a rental. It is often the case that only certain people are authorized to drive the car. This arrangement allows the rental car company to check to ensure that only those who are authorized to be driving the vehicle have driven the vehicle. Information sent to the central data is processing system within the car, maybe transmitted wirelessly hot external to car, 2 for example a central processing a system run by the rental car company. When the rental car companies data system to text that an unauthorized user is using the car, a message may be sent back to the car in the form of a voicemail or other type of warning that an improper driver is driving the car. The signals sent backm the rental car company may include, for example, and instruction to the engine to turn off within a certain time period.

It is noted that the RFID readers need not be embedded in the seats. The RFID reader or readers may be placed elsewhere within the car at strategic locations throughout the car. Alternatively, and RFID readers may be placed such that it s only the RFID information associated with driver of the car and not of the other passengers. Many variations are possible.

A further alternative is that the RFID tags or labels carried by the user are re-writable, and an RFID scanner in the car writes information to the RFID tags or labels as to where the user is sitting, whether he or she is driving the car, etc. The rental car company can then check each user's RFID card or tag or label upon return of the car to verify that only authorized driver's were driving the car.

Application No. 13: Air Bags That Adjust Based on Information on RFID

Passengers within a car each have an RFID tag or label or RFID card that identifies particular information about that passenger. For example, each RFID unit may identify the user by height, weight, various physical dimensions, and such, the user's sensitivity to impact, and or other variables. An RFID reader within the car, or possibly an RFID reader outside of the car before the car leaves on a trip, reads the information pertaining to each passenger.

The car is equipped with a computer controlled air bag system. Computer-controlled airbag systems are known in the art, such as systems that can adjust based upon the size and/or weight of the passenger. In current “smart air bag” systems, sensors (sometimes in the seats of the cars) feed data to a centralized control system that controls inflation of the airbags.

In the present application, RFID-stored information about the passengers within the car supplements or substitutes for information gathered in current sensor-based systems. The RFID information is transmitted to the central control system that controls the air bags. During an impact, the central computer system controls the inflation of the airbags to customize inflation according to the individuals be protected. That way, a small person, such as a child, is not hit by an air bag that is over inflated for that particular person.

Application No. 14: Car That Keeps Track of GPS Info and Knows Whos Driving Based on RFID, Stores in Memory

An automobile has an RFID reader that can read within the general vicinity of where the driver of the vehicle sits. The driver of the vehicle has an RFID card or label or chip or some other RFID identifying units and the associated therewith. The user's Identification is included on the RFID chip, and the RFID reader reads either continuous sleep or from time to time the identity of the driver in the car. This information may be stored within memory, and/or a transmitted in real time to a central computer system outside of the car. In this way, a car rental company, for example, can keep track of the identity of the driver of particular rental vehicles. It is often the case of that only particular people are permitted to drive a rental car, and in this way the rent-a-car company can verify that only authorized drivers have driven war are driving a rental car. In other applications, the agony of the identity of the driver may simply be kept as a log and stored in memory, and/or exported as desired.

It is noted that the RFID recognition system of this application may be used in conjunction with GPS information, so their record of not only the driver's identity, but also a record of the time and specific locations at which that driver was driving the car is maintained. This application may be extended to all the other passengers in the car, such that record is kept in the car at what time and/or at what location on earth. If re-writable RFID tags or labels or cards are used, the information can be recorded on the RFID chip itself in real time, or at specific intervals.

Details of how GPS systems work are known in the art. It is noted that there are now examples in the art of combined RFID/GPS that place RFID and GPS circuitry on a single unit.

Application No. 15: RFID Smart Closet

Clothes hanging in the closet and/or stored in a drawer in a closet, etc. each have an RFID tag or label or other RFID identification. An RFID reader is affiliated with the closet, either inside the closet or near the closet, to read all of the RFID tags or labels within the closet. The information is then sent to a computer system that correlates information on the RFID tags with particular pieces of clothing. A user display may be mounted in or near the closet to display the contents of the closet. The contents may be displayed by category, for example all shirts may be listed together, all pants may be listed together, all sport coats, and all suits maybe listed, etc.

The system may be interactive so that, for example, the user will be able to tell if a particular shirt is hanging in the closet or in a drawer in the closet. The computer system may be interactive, such that user may inquire whether not a particular item of clothing is with in the closet. The RFID reader may then be activated to read the contents of the closet the information that is scanned is sent from the RFID reader to the computer system, which processes the information and displays to the user whether not the particular item of clothing is in the closet. The display may also display where the item of clothing is with in the closet.

The RFID tags on the clothing may be re-writable, and information may be recorded such as the time and date of each dry cleaning or washing, date of purchase, and even number of times the clothing is worn and when.

Application No. 16: Method of Taking Attendance: Students Enter Classroom, Reader Takes Roll, Transmits to Office

Students in a school each have an RFID card or base and port tag or label on one or more of their books, which is in coded with information about that student. There is an RFID reader at the door to the classroom, or if there is more than one door to the classroom at each store to the classroom, and as each student enters the RFID reader reads the information on the RFID card or other item associated with that student. Information is transmitted from the scanner to a centralized computer data base within the school, said that classroom attendance is taken automatically. Whenever a student leaves the classroom, so long as he or she is carrying their RFID tag or band or label, etc., the system also reads their exit and communicates that to a central computer system. But in this way, real time attendance than that data may be maintained by the school. Also, the whereabouts of each student in the school may be known. RFID readers may be provided elsewhere in the school, such as at entryways to the school cafeteria, library, etc. The system may also delete implemented the use of RFID cards, in which the student must insert the card into a reader in order for the RFID data to be read. How however it is expected that RFID tags or labels will be more effective in that there'll be no time delay necessary in order to insert the card into a slot to be read. Also, RFID and scanners readers may be mounted in hallways to monitor where students are in real time and within the school hallways. RFID scanners may be provided at outside of the school, too, such as on playgrounds, patios, and at other areas to the school.

There are other uses for RFID in schools. A student's grades may be written to a re-writable RFID chip. All of the assignments for the semester (or other period of time) may be written onto the chip. Messages to parents may be written, etc.

Students may write love notes or other messages to one another by writing the text digitally onto an RFID chip, which the recipient must read with an RFID reader.

Application No. 17: RFID on Networked Desks so Lnow Who's Where

This application is similar to the application No. 16, except that an RFID reader is provided at each desk within the classroom, so that the identity of the students sitting in each desk may be determined. The desks may be networked, so that information read by an RFID reader at a particular desk is transmitted to a centralized computer system, so that information about where students are sitting throughout a classroom or throughout a school either in real time or in memory.

As an alternative, an RFID reader may be mounted elsewhere within the classroom, such as on the ceiling or a on a side wall of the classroom, or a series of RFID readers may be placed strategically throughout the classroom in order to read the RFID data associated with each student. If the RFID readers are placed strategically throughout the classroom, data from the readers may be run through an algorithm in order to determine which desk each student is sitting in based upon signal strength data coming from each of the RFID readers.

Application No. 18: Personal Computer Reads RFID to Log You in and Take You to Favorite Web Page, Load Favorites List, etc.

In this application, and RFID tag or label or card or other RFID article is encoded with information relating to a web page, such as on the Internet. An RFID reader associated with a personal computer, such as a peripheral to a personal computer, reads the information on the RFID tag and uses the information to load a favorite web page, set up a favorites list, enter information into personal address book or e-mail address book, and the like. In this way a user may travel from computer to computer and have each computer figure itself based upon the RFID information for that particular user. The RFID information may also include passwords and user name information, which may be automatically used to download particular software and/or open particular Web pages.

The RFID information may simply be a collection of information that allows the computer to access data about the user and other information from a centralized server or other centralized source, such that the user says information is simply retrieved off of a central server or other source exterior to be personal computer or terminal. as one particular application, the information on the RFID article may identify a particular user and a list of songs that the user particularly likes. The user may have purchased the rights to listen to the songs previously, and the RFID information allows the user have access to the songs from the central storage place irrespective of the physical location of the user. As a further example, and RFID reader may be located within an automobile. The RFID reader reads the information on the RFID chip, then access this the users song list from a centralized server external to the car, which then transmits the songs back to the car. The user then listens to their favorite songs the and at the automobile. Or, the RFID information made include a menu that may be visually or audibly displayed to the user, from which the user can choose which songs he or she wants to listen to at a particular moment. This application is of this and not limited to retrieving songs, type of organized information.

Information from the Web may also be written to RFID re-writable tags. Students may, for example, store notes taken about a particular website on a re-writable RFID tag. Or passwords or other information may be downloaded and written onto the RFID tag.

Application No. 19: RFID Labels on Files

In this invention, RFID tags are provided to be placed on files. The RFID labels may be printable, in that they are provided on a sheet which may be run through as standard home or office printer, such as an inkjet printer or the LaserJet printer. There are many different schemes for printing file labels, and patents on various types of sheets of file labels are held by a large number of different companies. However, if these many different types of file label systems may be modified to include printable RFID labels, instead of simple paper labels or the like.

In one embodiment, the RFID labels are re-writable, so that information about the file can be written to the label over time. For example, in a patent law firm, a variety of information is typically written on the outside cover of a patent file, such as the name of the application, the filing date, the application serial number, the status of claims and amendments, dates of Office actions, date of Notice of Allowance, and so on. All of this information can be written to a re-writable RFID label or tag associated with the file as the information is generated or received over time. In one embodiment, a copy of the most current claim set is stored on the RFID tag or label. In another embodiment, the entire patent application is stored on the RFID tag or label. All this information may be read with an appropriate RFID reader.

Application No. 20: RFID Address Label Versions of All Label and Sheet Inventions

This invention relates to the great many patents and pending patent applications on different types of printable label sheets. In this invention, standard paper labels are replaced with RFID labels. The upper surface of the RFID label is principle, it just as the upper surface simple paper label that replaces would be printable. However, in addition to the structure of the label sheet, an additional method step may be implemented in which the user is allowed to encode particular information on the RFID chip itself. Consequently, customizing the label has two steps. One step is to print the printable surface of the label. The other step is to encode specific information on the RFID portion of the label. This requires more effort than a simple paper label, however the end product is much more sophisticated and useful.

With a re-writable RFID label, information can be electronically written to and/or deleted from the label over time, as desired by the user.

Application No. 21: RFID Sports Tickets/Don't Need People to Take Tickets, Combine With Automatic Map Printout to Seat

A ticket to an event, such as an entertainment event or a sports event, includes an RFID label on which is encoded information about the purchaser of the ticket, and/or about the seat locations and and/or various other reformation. To enter the events arena, the user slides the ticket through an RFID reader, which may work, to the user's appearance, like present ticket readers that pull the ticket through an input slot and output the ticket in an output slot. The RFID reader reads in the RFID information on the RFID label that is on the ticket, and if the information is appropriate, the user is allowed into the event through a turnstile being unlocked or similar system.

An alternative feature is a system in which when the user enters the venue, a map to his or her seat is automatically printed out to maximize seat finding convenience. Other information may automatically be printed out, as desired. For example, there may be a phone message waiting for her a particular person who is entering a sporting event and, upon that person's arrival and insertion of a RFID ticket through the ticket reading mechanism, the phone message may be printed out for the ticket holder.

The ticket reader may be in communication with a centralized computer system having a database, computer programs, and/or other features. The computer system can route information to the entrant, such as messages received, seat location, etc., and/or may serve to store information about the entrant in a database. Consequently, a record of the user's attendance at events may be maintained. In one embodiment, specific customized information and/or discount coupons may be printed depending upon events that the user has attended in the past, or upon user preferences that the user has provided previously.

In another embodiment, an RFID reader reads information on the ticket after the user has taken his or her seat. The information may be sent to a centralized computer system, and the identity of the occupant of each seat in the venue may be centrally tracked. RFID readers may be placed throughout the venue, to track the user as he or she moves about.

RFID readers in the venue may read the ticket and provide guidance to the user as to how to get to his or her seat. When the user approaches the proper row, a light or other signal may go on. When the user approaches the proper seat, another light or other signal may go on. In this way, RFID readers help users to their seats, even when the lights in the venue are low. In one embodiment, RFID readers are networked together, either locally in a region of the venue (such as in one section) or globally throughout the entire venue. The RFID readers may report to a computer which, when it receives row and seat information that an RFID reader has read, controls the locator lights at the proper row and seat.

As another alternative, an RFID reader may not necessarily be networked with other RFID readers. However, when a particular reader reads an RFID ticket for a row with which the reader is affiliated, the reader sends a signal that causes the light at the proper row to turn on. A single RFID reader may be affiliated with several rows.

A re-writable RFID tag or label may be used, with information being written onto the tag or label at different points in time. For example, the user may have a single RFID card that permits the user entrance to particular events, based upon information electronically stored on the RFID card. When the user enters an event, confirmation of the user's attendance may be written onto the card.

An RFID ticket may have multiple uses. For example, one use may be to provide entrance to the event. However, the ticket may also provide the user with a certain amount of credit toward purchase of food or other items. RFID readers at food or other concession stations can determine the value of the credit by reading the RFID ticket. In the case of a re-writable RFID ticket, the amount of credit left after a purchase may be written onto the ticket, to be read the next time the user makes a purchase.

The RFID ticket may include further information. For example, a physical description of the ticket holder may be stored on the RFID chip, to confirm that the entrant is indeed the owner of the ticket.

As an alternative to an RFID ticket, the user may wear an RFID bracelet or have some other RFID device.

Application No. 22: Combination Function Invitation and RFID Chip to Allow Admittance

This invention relates to an invitation to an event, such as to a wedding or a party or other function, in combination with the RFID label or chip that is affiliated with the invitation. It is a problem that too many high-profile events people will attempt to obtain a counterfeit invitations in order to gain admittance. However by providing an RFID label on each invitation, the attendee presents the invitation at the entrance, whereupon the RFID label is read by an RFID scanner. Information on the RFID label verifies the user's activity or the authenticity of the invitation, etc., and may also allow individual information to be printed or displayed for that particular attendee upon entering the event. For example, a map to the user's table baby printed out, or a customized reading from a host this may be displayed or printed, or any of a variety of other customized things may be done based upon the RFID scanner successfully scanning the invitation. For particularly important attendees, a signal may be sent to the host for hostess that a particular person has arrived so that the host this can personally greet that attendee as they are entering the function.

A re-writable RFID label or tag may be used in conjunction with the invitation. For example, when an attendee is given a gift, the RFID system may write onto the RFID label or tag that the attendee has received the gift, and a further gift will not be given. The RFID label or tag may be used for other special purposes, such as for playing games, in which information such as clues are encoded on the RFID label or tag and can be read at RFID reading stations.

Application No. 23: Roll of Tape With RFID Built in (Example Use: Lay on Floors to Guide Robots and/or Other Machines, etc.)

Included: perforations, microperforations, series of chips for different frequencies, then perforations, irregular spacing, PENI chips, is a roll of postage stamps, constructed with FSA, methods: tape onto structures to guide robots or machines, each RFID programmed with a unique mailing address; upper surface is printable and putting roll into printer and printing on top, tearing off at perforation. Tape that has two or lots of RFID transponders across the width. Tape that has many nano-RFID chips distributed all over the layer (longitudinally and latidunally) on a layer formed with FSA or other method either in sequence or randomly.

U.S. Pat. No. 6,478,229, entitled “Packaging Tape with Radio Frequency Identification Technology” illustrates a type of tape that incorporates RFID technology. Several improvements can be made to the embodiment that this patent discloses.

RFID chips and antennas are provided on a roll of tape. The tape has a top layer which may be of a typical tape material, such as a polymer, a paper, another fiber-based type material, or other material, and a bottom layer that can be any of a variety of materials as above. The bottom layer is coated with a layer of adhesive, which may be pressure sensitive, permanent, or any of a variety of different adhesives known in the art. In between the layers, is an RFID chip and associated antenna. The RFID chip may be printed on one or both of the top or bottom layers, may be adhered to one or both layers, may be sandwhiched in between the layers which are themselves adhered to one another, or otherwise affixed in between the top and bottom layers. There may be additional layers of material underneath and/or above the RFID chip and antenna to protect the RFID chip and antenna from damage and/or dirt etc. The RFID chip and/or antenna may be encased in a protective material in some embodiments, to protect the chip and/or antenna. Numerous variations are possible. Reference is made to U.S. Pat. No. 6,478,229, which describes further approaches and provides additional information.

In one embodiment, the RFID chips are spaced at a predetermined spacing, so that a user may lay down a long strip of RFID tape and know that the RFID chips and antennas are spaced at a predetermined spacing. The bottom layer will typically be an adhesive, although the adhesive may be covered with the release liner. Release liners are known in the art, and are typically coated with a substance such as silicone to make release fairly easy. However, in one embodiment, there is no release liner.

One use of RFID tape is in housing construction. On the concrete slab, RFID tape may be applied in a particular pattern. Then, when carpeting or tile or another floor covering is applied, the RFID chips and antenna remains in place on the floor. The chips may have been in coated with particular information in advance, prior to the floor covering being added. Or the RFID chips may be of the rewritable type.

Spacing of the RFID chips and antennas may be useful in many applications. As one very specific example and not for limitation, the RFID chips may be encoded with sequential Information. As a robot or other automated device roams the floor, it may read the RFID information on the RFID chips as it travels. In this way, for example, it can determine exactly where it is in the room. The RFID chips may also be programmed with specific instructions, such that the robot or automated unit may know that when it reaches a chip having a particular sequence of information, the robot or automated device is to perform a certain task. As a further example, in an automated vacuum, fitted with an RFID reader, the automated vacuum may know that it needs to turn right a particular number of degrees at when it reaches a particular RFID chip. There may be an onboard database on the robot that correlates certain codes read from RFID tags to certain actions. Or, the information on the RFID label may itself be an instruction to the robot, without need for an RFID code-to-robot instruction database onboard the robot or automated device.

Many other applications can be imagined for this type of RFID tape. Applications are not limited to using the tape on floors. The tape may be adhered to walls, to packages that are being mailed, or to any of the number of applications in which normal tape is used. The difference being, that this particular type of tape is embedded with RFID technology, so that a great deal of information can be stored on the tape and used in many applications.

In alternative embodiments, the spacing of the RFID chips and antennas may be in a regular, but non-uniform pattern. For example, the spacing between each RFID chip antenna does not have to be exactly the same. The spacing may gradually increase, or may gradually decrease, or may be alternated in various patterns, may be spaced exponentially, etc. The particular spacing depends upon the desired use of tape.

In one embodiment, the tape may include RFID chips that operate at different frequencies. In some countries, certain RFID chips must operate at different frequencies then in other countries. So, for example, the tape may include different frequency chips, perhaps in sequence. In one embodiment, there are three chips in each sequence. One chip on the tape operates at one frequency, the next chip on the tape operates at another frequency, the next chip operates at yet another frequency, all of the chips being encoded with the same information. Consequently, the information can be read in different countries operating at different frequencies, because at least one of the chips will respond appropriately to the reader in that particular country when an interrogation signal is sent from the reader. This type of tape may be used in international mailing, for example, where the RFID chip may be encoded with a mailing address. When the package arrives in one country where one particular frequency is used, the RFID chip on the tape that has been applied to the package that corresponds to the frequency in that country responds to the reader with the address information. When the package is then transferred to another country where a different frequency is used, the RFID chip on the tape corresponding to the frequency used in the new country responds to a reader in that country, and so on. It may be desirable to write information along the way to one or more of the chips to document shipping details or other information. The information may be written to the chips of only the frequency of that country, or may be written at different frequencies to all of the chips, as desired.

Another approach to making RFID tape is to use PENI chips, as described earlier in this document. In PENI chips that have the antenna as part of the chip, the size can be made quite small. In one embodiment, PENI chips are used in longitudinal sequence only on the tape. In another embodiment, the tape includes more than one PENI chip across the width of the tape, as well. For instance, as only one example, three PENI chips may be spaced across the width of the tape. One PENI chip operates at a frequency commonly used in the United States. Another PENI chip operates at a fequency commonly used in Japan. Another PENI chip operates at a frequency commonly used in Europe. In a related alternative embodiment, the PENI chips may each be encoded with the same information across the width of the tape, so the same information is read in whatever country in which the reading is being done.

In another embodiment, one layer of the tape is microembossed and is filled (as for example by Fluidic Self Assembly) with RFID and/or other electronics, in a manner described in patents held by Alien Technology and in literature and papers available from Alien. The layer may be the bottom layer of the tape, or an additional intermediate layer in between the top and bottom layers. The layer will typically be made of a polymer, but can altertively be made of microembossed paper or other embossible material.

In various embodiments, performations or other lines of weakness may be used to easily separate pieces of the tape from the roll. For example, a line of weakness may be provided across the tape after a certain number of chips longitudinally. The user could tear along the line of weakness to remove a section of the tape (along with a certain number of RFID chips in the section). In one embodiment, each section is an RFID postage stamp. In another embodiment, each section corresponds to a particular mailing or delivery address, such that the roll of tape is encoded with a mailing list (such as for holiday cards, bulk mailing of junk or other mail, or a list of addressee's for other types of deliveries). The user removes one section, applies it to a package or envelope, and then that section serves as an electronic postage stamp or an address label or both simultaneously. Electronic messages to the recipients may be encoded on the RFID chips as well, and the messages may be customized for each section.

The top surface of the tape may be printable, and may be printed in a printer for printing rolls of printable tape. In one embodiment, a printed address is printed on a section of the tape, and the same or related address is encoded on the RFID portion of the tape. In another embodiment, a price (as for a price of a supermarket product) is printed by the printer onto a section of the tape, while the price information is also encoded onto the RFID chip. A store worker may apply the section of tape to the product by hand, using a hand-held dispenser of the type known in the art, thereby putting a visual price tag on the product and an electronic price tag at the same time. Various other information may also be imprinted and/or encoded, as desired. The tape may be pre-perforated to form price tag segments, or the dispenser may have a cutting edge that cuts the tape at a desired interval, or both.

In another embodiment, the top and/or bottom surface of the tape is marked with markings indicating where the tape is to be cut, in order to avoid cutting into an RFID chip and/or antenna. The marking may be a straight line across the tape, or a broken line, or dots, or any other marking suitable for the purpose.

The top surface of the tape may be preprinted with information about the RFID chips and/or other electronics that are part of the tape, such as the frequency at which the RFID chips operate, information about other electronics that are also part of the tape (which might include microcontrollers, microprocessors, memory, or any desired electronics that may physically fit within the structure of the tape). That is, the tape is not limited to having RFID chips and antennas only, but may have circuits that include RFID chips and/or other structures. In another embodiment, the tape is provided with various electronics, but not RFID chips and/or antennas. Or, the RFID electronics may be provided in sequence on the tape with other types of electronics. Perforations or other lines of weakness may provide for easy tearing of the tape in between the RFID circuitry and the other circuitry. Or, if the RFID circuitry and the other electronics are electrically interconnected, perforations or other lines of weakness may be provided after the RFID/other electronics circuit. Electronic circuits that incorporate RFID chips and antennas but include other electronics as well are known in the art.

As another approach related to the previous paragraph, a tape dispenser may both encode the RFID chips and dispense the RFID tape onto a product within one device. The encoder would encode the RFID chip as it passed by on the tape roll, then that portion of the tape would proceed to exit the dispenser for dispensing. A keyboard may be provided on the the dispenser for the user to enter information to be encoded on the RFID chip, and/or to provide other information such as what is to be printed on the label (if the dispenser is also a printer), how often to cut the tape (if the dispenser is used to cut tape and the tape is not already provided with lines of weakness), and/or other information. The dispenser may include a visual display to be used in conjunction with the keyboard or other input device, or to display information pre-encoded on the RFID chips, or provide instructions to the user. The dispenser may also be in communication with a centralized computer system that programs the dispenser from a central location, without the need for the user to enter the information to manually. Many variations are possible.

In another embodiment, both RFID and GPS circuitry is incorporated into the tape. This may be useful in, for example, package tracking applications. Combined RFID and GPS circuitry is now known in the art. Alternatively, separate RFID and GPS circuitry may be incorporated onto the tape, and be provided in sequence or side-by-side, or in any other desired order. In one embodiment, both the circuitry and antennas are printed on the tape. Methods of printing RFID circuitry are now known in the art. In other embodiments, just the antennas are printed and/or just the circuitry is printed.

Application No. 24: Schoolbus Reads Which Kids Getting On, Keeps Record Internally in Memory and/or Transmits to Central Location (If Bus is on Network)

In this invention, schoolchildren who do step onto a school bus are identified by the RFID card or chip that they carry. There is an RFID reader at the entrance to the bus that reads the RFID information and identifies the student as he/she enters the bus. This information may be stored in some central memory, and/or may be transmitted wirelessly to a central computing system outside of the bus, or the full student identification information may be encoded on the RFID chip. So, for example, a school district may be able to keep track of the location of many students who are on school buses throughout an area of the city, simultaneously. Then, when the students exit the bus, the RFID reader reads the RFID information associated with each student once again. Used in conjunction with GPS information, which may be supplied by a GPS unit on the bus or, in some very particular embodiments by a GPS systems that are on the RFID label or an RFID card or other RFID object. The GPS information may be correlated with the RFID information, such that a record of exactly where it and that what location a particular student caught on and or off the bus. This information may be correlated with time and date information, such that our record of when students got on and off the bus and where they got down and off is kept in a central data base system. In one embodiment, RFID student identificaiton information is embedded in the students school uniform as, for one example, a tag that is sewn into the school uniform. In another approach, the student is denied access to the bus if they don't have RFID student identifying information.

Application No. 25: RFID on Each Car Wheel, (Example Use: Reader on Highway, Catches Speeders)

An RFID transponder is provided on an automobile. RFID readers are placed along the highway or street at regular intervals. The speed of the automobile as calculated based on the rate at which the automobile is detected by the various RFID readers along the street. In the embodiment, the RFID system is active, such that the RFID unit on the car has a power source of its own in order to send signals back to the RFID readers.

In another embodiment, the car is simply provided with a passive RFID label or tag that RFID readers along the side of the road or embedded in the road or stationed atop stoplights or underneath overpasses or at other locations along the road read. By tracking cars by RFID information, speeders or violators of other traffic rules (such as turning left where there is a “no left turn” sign) can be caught without the use of police.

That is, with respect to speeding violation, if a vehicle travels between two points of the known distance between one another within a certain time interval, the average speed of the vehicle between those points can be easily calculated by calculation circuitry. If the average speed is higher than the posted speed limit, information about that car may be sent to a central computer system, which automatically produces a speeding ticket that is sent to the owner's home. The RFID information on the vehicle may include the vehicle identification number, of the license plate number of the car, and/or various other information.

In another embodiment, the system does not merely check for speeding, but may simply keep track of the identity of cars at specific points along the road or highway. That information may be transmitted from the RFID reader to a central computer system, so that authorities and/or others may know at any given time at the location of the particular vehicle. This information may be especially useful in locating stolen vehicles, or in finding vehicles that are spent suspected in child and abductions where other critical situations. The network may be made nationally, such that RFID readers are deployed along major highways and roads throughout country, so that vehicles that authorities are seeking may be found in real time. Alternatively, the vehicle information may be stored locally and not shared with a centralized command computer system, for local processing of data for local needs, such as whether or not a particular stretch of road needs to be widened to accommodate a particular traffic flow. Many applications of this technology may be imagined.

As a further alternative, the roadway itself may be provided with RFID tags, these tags may be within the road itself, or may be placed alongside the road, or maybe placed inside reflectors or within protective coverings along lane lines. Automobiles may be provided with RFID readers that read information from the RFID tags on the roadway and/or along the side of the roadway. Information on the RFID chips may include location information to be used in conjunction with and/or instead of GPS information, or the RFID information may be informative of roadway conditions or other information that is programmed into the chips daily, assuming that the RFID chips are of the type that may be rewritten. The RFID chips may be stand-alone, or they may be networked together to provide information to drivers. Networking the RFID chips may provide a convenient way to change the information encoded on the RFID chip from a central location.

In one embodiment, the RFID tag is provided in a stem cap that screws onto the stem of one or more of the tires. The RFID circuitry and antenna is in housed in the top of cap. The top of the cap may be elongated as compared to a typical stem cap, if necessary, or otherwise dimensioned in order to accommodate the RFID circuitry and antenna. In one embodiment, the antenna extends outside of the cap, with the RFID chip being housed within and protected by the top of the cap. Small openings in the cap may be provided for the antenna to enter into the cap and to be in connection with the RFID chip.

Application No. 26: RFID Key to Operate Common-Area Laundry

One problem that residents face sometimes in apartment complexes or other units where there are shared laundry facilities, is that users from outside the area come in to use the limited number of machines. Consequently, users may be provided with an RFID key which is encoded with specific information identifying the holder as someone who lives at the complex. An RFID reader reads the RFID key and, if the information included on the RFID key is correct, the washer and dryers are unlocked for use.

For example the RFID reader may send a signal upon receiving correct information from an RFID tag to a centralized computer system, which then issues commands to the washer and dryer enabling them to work. This system may be used in conjunction with the typical coin-operated laundry facility input coins into slots in order to make the washer and driers work. That is, the user may still need to insert coins to the machines make them work, but if the appropriate RFID information has not been read by the RFID reader, even depositing coins in the slots will not make the washer and dryer work. In this way, only those users who are authorized to use the laundry facility may use it, thereby solving the problem of people from outside the area coming in and using the bill washing facilities. Circuitry to accomplish the forgoing is known in the art.

Application No. 27: RFID to Automatically Adjust Weights/Treadmill Settings in Gym

In a gym, there are a great many exercise equipment types. For example, there are treadmills, stairs steppers, wait, resistance machines, and a great many exercise machines. However, each of these machines typically require accustom setting depending on the particular user. For example, at the bench press a user may want to lift 30 lbs. of weight based upon the training regimen that the user is undertaking. Whereas another user may wish to lift a hundred or more pounds at a single time. This particular information may be stored on an RFID chip in the form of an RFID tag or label or card.

Information about the user's particular settings and that the user desires of a particular machine is stored on the RFID. When user approaches the machine, the user may insert an RFID card into a slot that reads the RFID information, or the user may be wearing in RFID Bay and that an RFID reader wares, or a user may have an RFID chip in some other form on or in their clothing, etc. that an RFID reader reads. The information that the RFID reader reads is then transmitted to a computer control system associated with the exercise equipment, and the equipment is adjusted accordingly.

For example, in a resistance machine, the RFID chip may inform the machine of the resistance that is appropriate for this particular user, and then the machine automatically set and that particular resistance. The user does not then have to manually reset the resistance of the machine to change it from the resistance that the previous user was using. Similarly, on a treadmill, an RFID reader in conjunction with a particular treadmill me read from an RFID chip that this particular user typically exercises for 45 minutes at 4.5 mi. per hour and/or operating on eight particular exercise regimen that may include increasing the speed and/or an angle of the treadmill during the workout at particular moments.

The RFID chip may be a read-only type chip, in which case the user may periodically exchange chips when he or she wishes to change to a higher level of resistance or change the regiment on the treadmill or otherwise change the workout regimen. Alternatively, the RFID chip may be of the rewritable type in which as the user changes his or her workout regimen, a RFID writer writes new information to the chip that the various machines may read. Various excercise machines may write performance and history information to the RFID chip. So, for example, the user's workout history may be stored on the chip and updated as the user continues to work out over time.

In this way, RFID technology can greatly decrease the time that a particular person must spend changing settings on different machines within a gym, thereby either increasing the amount of exercise the user can accomplish in a given amount of time, or reducing the amount of time the user would normally spend on a particular workout regimen.

Application No. 28: RFID w/Clothes Measurements, Save Shelf Space at Store, Get Proper Size

A user has an RFID tag or cards or band with information encoded thereon corresponding to the users clothing measurements. The measurements may include, for example, for a woman shoulder with waist size, chest size, distance from neck to a small of back, etc. The RFID tag might also include the user's shoe size, and/or other information about the user such as body type information, eye color, hair color, skin color, or other personal information about the user. The user takes this RFID encoded information to a clothing or other personal effects type store where an RFID reader reads the information from RFID tag or card or band. The store can then provide the user with clothing in the proper size, and/or colored and/or design for the user's particular body type.

As an example, the body type information encoded on the RFID chip might indicate that the user is slender and short. Consequently, a computer system at the store may recommend, based on that information, combinations of clothing that make the user appear taller, or at least deemphasized the user's slight stature. The computing system may use the RFID information to suggest any of a wide variety of different clothing combinations to correct particular body type situations. This type of recommendation is given in a general way in certain wide circulation magazines, in which people of certain body types are shown wearing certain types of clothing to make them appear more attractive.

Another application for this technology is that the store may reduce the need for shelf space by displaying, for example, a single pair of a particular design of pants or other clothing. When the users RFID information is read, the appropriate size may be chosen from a store of the pants held in a backroom of the store or other storage area, thereby allowing the store to devote more of the display area of the store to displaying clothes rather than storing different sizes.

As yet another application, the RFID information may include hair color, information about the user's skin tone, height, weight, body type, age, and any particular appearance issues that the user is working on. Based on all of this information, a programmed computer system may suggest the various products, clothing and patterns, fabrics, colors, and any of a wide variety of fashion suggestions for that particular person.

The system may include a camera, for example, to take a photograph of the user. The computer system might then show on a display screen what the user would likely look like wearing various of the suggested clothing and/or other items. Technology for doing so is known in the art. The information about the user's shoulder width, height, bust size, leg length and/or inseem and/or other information can be very helpful in generating an accurate model of the user on the screen.

It should also be noted that by providing the user's measurements on the RFID chip, a computer system is able to correlate a particular clothing size from a particular manufacturer/label and particular clothing product to the user much more quickly than if the user work to try on the clothing in a dressing room. It is well known that, for women's clothing in particular, size information is not consistent from brand to brand, or even among different clothing from the same brand, and that a size “4” in one designers model and can be vastly different in size from a size “4” in another designer's model. Using a data base, the system can take the user's measurement and/or other information that is stored on the RFID tag, and find the proper size for the user for a particular brand and/or model of clothing, thereby saving the user significant time in having to try on various different sizes of the same clothing outfit.

It should be noted that this particular application can also be implemented without an RFID chip. For example, the user might be able to use a stand-alone terminal and entered the user's measurement information directly, and a data base of manufacture information compared the users measurement information to the manufacturers size scheme to determine which size is appropriate for that particular user. That information may all be displayed on a display screen that the user can see. Alternatively, the same sort of display and computer system can be made available to salespeople, who can do the same thing. In this way the need for trying on many different dress sizes in order to find a particular size and for that particular manufacturer that fits the wearer is a greatly reduced. This system may also be implemented over the internet, with a client tying into a website having an interface and a database that allows for user data input, provides processing software including an interface with the database, and having output for the user at the user's terminal.

As the user's measurements change over time, or other personal information about the user changes, updated information about the user may be written onto the RFID tag, if the RFID tag is of the rewritable type, or a new RFID tag may be created for the user with the new information. Alternatively, a card like a credit card may be provided having an RFID label thereon. The RFID label may include the user's credit information as well as the user's and various other personal information, and thereby combining payment information with information that can be used to get a proper clothing size or style or color or so on. If the user's personal information changes, the old RFID label may be peeled off and a new RFID label with updated information may be applied instead. Various other schemes may be imagined.

Application No. 29: RFID Keyring w/Make, Model, Year of Car, Save Time at Auto Parts Store Finding Parts

It is often difficult in an auto parts store to find the proper part for an automobile. For example, when a user wishes to replace the windshield wipers of his or her car, she must go into the auto parts store, opened up a catalog and look for her make a model in your car in order to find the proper model number or sku for the windshield wipers your she needs for his or her car. It would be much more efficient, if the user could simply spend the information about the make model in year of his or her car into a central data system, which then would tell the user which model number of part year she needs. In one application, an RFID tag is provided for the user's key ring. On the RFID is encoded information including the maker model and a year of their car, as well as possibly other information about the car such as particular options that the car has. Within the auto parts store, there could be new in numerous stations at which a user could stand up there RFID chip with the vehicle information thereof and, and the user could be interactively tell of the terminal of what kind of bottle part the user needs. For example, if the user needs a headlight, the system will have scanned the RFID information on the RFID chip and will know the make, and model and year of the user's car. The terminal will then be able to quickly, by interconnection to a computer system with database, tell the user by way of display or other means the model number of the headlight that the user will need to purchase. Many different auto parts can be accessed in the same way using the same terminal.

This could save a great deal of time for the average auto parts consumer, who would then not need to consult numerous catalogs and/or reference charts in order to find the particular auto parts that they need for their car.

In one embodiment, the RFID chip and antenna are housed at the top of a car key as, for example, within a plastic housing at the top of the key, adjacent to where the key fits on a keyring.

Application No. 30: Keep Track of Who's Driving Around Neighborhood, Where They Go (Gated Communities, for Example)

In this embodiment, an automobile is provided with an RFID tag or label. RFID readers are placed around the roads of a neighborhood, such as a gated community. The RFID readers may be placed in the roads themselves, on curbs, in curbs, in special protective boxes alongside sidewalks, or any other place in the neighborhood where it is capable of reading the RFID information encoded on the RFID device on the car, which is typically a passive device, although in one embodiment the RFID device on the car is active or semi-active.

In one embodiment, the RFID reader is a stand-alone device that is not networked to other RFID readers. There may be, for example, just one RFID reader, that is positioned in front of someone's house. When a car pulls up, the RFID reader reads the RFID information on the car, and then may, for example, transmit the information read from the RFID device into the house (by a cable, wirelessly, or by any other method known in the art). There may be a display in the house and a processor, that processes the information sent from the RFID reader and displays related information onto the screen. The system may allow the occupants of the house to know information about the car that has just parked in front of the house, the identity of the people in the car, the owner of the car, and/or other information stemming from what is encoded on the RFID chip and read by the RFID reader. The in-home processor may, in one embodiment, have a database that correlates certain codes encoded on an RFID device to certain people. In other embodiments, the RFID device acts as its own device, in that it provides all of the information necessary to the in-home processor for information to be displayed to the occupants. The display may be visual, an audible signal, or other device known in the art.

In another embodiment, two or more RFID readers are networked together, such that RFID information that either of them reads is transmitted to a central computer system. The computer system keeps track of the RFID information that has been read. A networked series of RFID readers may be used, for example, to track the location of the automobile within the community as the automobile drives through. So, for example, if a car drives down one particular street, turns left, then heads down another street, the system can follow the car by reading the RFID information as the car travels, with the information being transmitted back to a central computer system. The central computer system may include a display to display the car's progress in some fashion, such as showing where the car it is had given times. This device may be useful for high security neighborhoods, where records may wish to be kept of which cars is been in the neighborhood, and where they have gone once they've been inside the gated community. A database may be kept in which is stored information about where cars have been at particular times.

This idea may be extended to tracking individual people, who may or may not be in cars. The individual would have an RFID tag, or card, or RFID implant, or other RFID device, and readers throughout the neighborhood would read the RFID information as the user walks or runs through the neighborhood.

The RFID readers may be stand-alone, in which case they may transmit information to a household or other location to report the information read from the RFID chip. Alternatively, the RFID readers may be networked together so that information is transmitted to a central computer system and/or memory system to retain a record of the path that a particular individual follows as he or she walks through the neighborhood.

As a further alternative, the RFID readers may report to more than one centralized computer system (perhaps by reporting to one local centralized computer system, which then communicates with other, remote centralized computer systems). For example, RFID networks from many different neighborhoods could report to a central computer system that would keep track of traffic information from many neighborhoods at once. As one example, many local neighborhood networks of RFID readers could report to a centralized computer system to which local police and other emergency personnel would have access. The local authorities would then be able to monitor the identity and travel patterns of vehicles and/or people through different neighborhoods. The local authorities might, in some embodiments, to be able to keep track the speed of individual automobiles as they progress through neighborhoods. The authorities may also be able to keep track of areas within neighborhoods at which automobiles travel excessive speeds, to help neighborhood planning officials determine where to put speed bumps or otherwise asked to reduce speed of vehicles in particular areas.

Information that might be on the RFID tag or chip or cards may include such information as the vehicle identification number, and/or the license plate number, and/or if the identity of the owner of the vehicle, and/or the some lesser amount of information and, such as simply the make model and year of the vehicle, its color, and/or other information in short of the vehicle identification number or license plate number.

In one embodiment, the RFID circuitry is on an RFID label that is applied to the license plate of the automobile. This label, for example, may be provided as an annual registration renewal sticker, or may be placed elsewhere on the license plate. Of course, RFID device may be an active or semi-active RFID device, or may be a passive device placed in any of the large number of places within the car, in such as on one or more of the wheels of the car, inside the engine compartment, inside the passenger compartment, on the frame of the car, in the or anywhere else on the car, such that an RFID reader can read the information encoded on the RFID tag or label.

In one approach, a house occupant may instruct a computer system to expect a particular car. When the car arrives in the neighborhood (as reported by one or more RFID readers), the computer system may be programmed to turn on the porch light, to sound a bell, or take other action. Or, if a particular car or individual is a threat (as when a protective order has been issued against an abusive spouse who drives a particular car or cars), when that car or individual is detected by the neighborhood RFID reader system, the home computer system may automatically lock the doors, sound an alarm, send a message to security personnel, and/or take other actions.

Application No. 31: RFID as Dental Implant

In this invention, and the RFID chip is implanted into a tooth as a dental implant. The RFID chip may be very small, such as those manufactured by Alien Technology Corp., and the antenna may be fashioned out of a metallic tooth filling, as one embodiment. In other embodiments, the antenna is simply part of the implants and is not have a duel capacity roll as a filling.

Application No. 32: RFID Thumbtack

In this embodiment, a thumb tack of the type having a sharp pointed end and an enlarged opposite end is provided. In RFID chip is embedded within the enlarged opposite end. Various types of information can be stored on the RFID chip, and can be read by in RFID reader in a conventional manner.

Application No. 33: RFID Doorstop

In this embodiment, and RFID chip and antenna is installed within a doorstop. This may allow for example doors to be held op in the house that is on display, such as at a designers show house. As users walk throughout the house, they encounter the RFID doorstop, and using a device with a hand-held RFID reader, they can be informed of different information about the design and/or designers of the room. This is only one of many potential applications for and RFID embedded doorstop.

Application No. 34: RFID Identification of Boats or Ships at Docks

In this invention, the boat ownership is provided with and RFID tag or label or other RFID device. The RFID reader is provided that the dock. Alternatively, a plurality of RFID readers may be provided at the dock. When the boat docks, the RFID reader reads the RFID tag or label or other RFID device, and is able to identify the boat and confirm the identity of the boat that has docked.

The RFID reader or readers may be interconnected in a network that reports to a central computer system. So, for example, if there are many docks, the RFID readers on all the many docks may be networked together, all reporting to a central computer network that can keep track of which boats are at which docks, as well as other information.

This idea may be extended to trains pulling into a station, busses pulling into a terminal, airplanes pulling into a gate, automobiles pulling into parking places, and many other applications that can be imagined.

Application No. 35: RFID on Cups w/Specifics of Favorite Coffee Drinks (e.g. for Express Use at Starbucks)

In this invention, an RFID chip and associated antenna is embedded within a cup or other drinking vessel. When the user takes the cup to a vending machine or to a café or to another drink-dispensing unit, information on the RFID chip is read in order to ascertain certain information about the drink and/or preferences of the user and/or payment information, such as an account number from which to deduct a payment.

For example, the user may take a mug to Starbucks. Starbucks has an RFID reader that reads the RFID information on the mode. The RFID information may indicate the type of milk the user likes to use (nonfat, low-fat, or whole milk), the type of drink the user likes (latte, cappuccino, regular coffee, hot chocolate, chai, green tea, etc.). If the RFID chip may be of the rewritable type, so as the users preferences change over time, the information on the chip may be changed. The Starbucks, or whatever vending machine or store reading the information, may also use the RFID information to keep track of the customer's purchases and award the customer some benefit upon purchasing a certain number of drinks or other marketing awards, such as discounts on future or current purchases. A central computerized system may retain the RFID information in a database, for marketing analysis or other use.

Alternatively, if the RFID chip is rewritable, the beverage dispenser may write information onto the chip, such as the history of beverages with which the cup has been filled. In another embodiment, the cup is provided with a pre-paid number of beverages, or a pre-paid amount that may be applied toward the purchase of beverages. As beverages are purchased, the RFID transponder may rewrite information to the chip, or write additional information to the chip, in order to maintain a record of the number of drinks the user has remaining, or to update the credit balance on the cup, or so on.

Application No. 36: RFID on Bridges With RFID Tanks on Top of Cars, to Detect Speeding

In this invention, RFID readers are placed on bridges and overpasses over highways and roads. Automobiles are provided with encoded RFID chips, which may be either passive or active or semi-active RFID units. The distance between the bridges and/or overpasses is known. Consequently, information about a vehicle that the RFID reader unit reads may be transmitted to a central computer system. Subsequently, information that the next (or the several next RFID readers) reads from the same vehicle may be transmitted to the same central computer system. The central computer system can calculate the average speed of the vehicle, and if the average the vehicle is above the speed limit, may automatically issue a ticket to the owner of the car.

Ideally, the RFID chip's programmed with the vehicle identification number of the car and/or the license plate number of the car. As a further alternative, the RFID formation that may be somewhat more restricted, such as simply the make and model and of the car and some unique car identifier, such that a ticket is not necessarily issued, and the identity of the owner may or may not be determined, but the information may be used for statistical purposes, such as to determine where more Highway Patrol or police officers should be stationed.

Application No. 37: RFID on Studs in a Wall and RFID Reader That Acts as a Stud Finder

Details of how prior art stud finders work are known in the art.

In this application, RFID labels or tags or the other RFID objects are placed in studs or other wooden members inside walls. One form of an RFID object may be a nail-shaped RFID member that is nailed into the studs or other nailable members inside the wall. Another form of the RFID object may be a simple RFID label that is adhered or otherwise attached to the studs. However, these examples are not limiting. Any RFID tag may be attached in an appropriate manner. The tag may be active, semi-active or, in most embodiments, passive.

After the building is finished, and a user wishes to find the location of the stud in order to hang a picture or other object, the user uses a hand-held RFID reader that is able to determine the strength of the RFID signal that it is receiving. When it receives an RFID signal, it monitors the strength of the signal until it finds a maximum signal strength. At that point, it knows it is found in a stud.

The hand-held RFID reader may include a series of lights that light up sequentially as the signal from the RFID objects in the stud grows stronger and stronger. This invention solves the problem faced by many home users of stud finders who have determined that conventional stud finders are often inaccurate. However, using an RFID-reading system, the likelihood that the precise location of a stud or other wooden member within the wall is found is greatly increased.

In another embodiment the RFID reader reads specific information off of the RFID member that is in the stud or other member within the wall. So, for example the RFID reader may be able to read information about the particular stud that has been found, within the overall scheme of the building, such as its dimensions, a stud identification number, whether any electrical conduits are nearby and so on. Alternatively, the RFID reader may be able to convey whether or not it has found a stud, or whether it has found some other type of member within the wall.

As a further alternative, other members within the wall may be labeled with the RFID objects. For example, plumbing pipes, electrical wiring or any of a variety of other standard objects that are found within building walls may be labeled. This may be of assistance in future years to plumbers and other technicians looking for certain types of structural members, HVAC components, and so on. The hand-held RFID reader that the user holds may have a display that indicates the user what type of member within the wall it has found. The invention is not limited to finding members within walls, but also may be used to find members within floors, and/or other areas of a building or house.

Application No. 38: The RFID Tags or Labels Inside Tires so That Characteristics of the Tires Can be Read From the Outside

In this invention, an RFID label is applied to the interior of a tire. The label is encoded with characteristics of the tire, such as size, recommended air pressure and so on. Characteristics of the tire may then be read with an RFID reader from the outside of the tire. Any of a wide variety of information may be stored on the RFID label, including the vehicle identification number, the license plate number, the date on which the tire was installed on the car, the size of the tire, other information about the tire, or any of a great variety of information that may be desired to be stored in a tire.

If the RFID label or tag is rewritable, historical information may be written to the label or tag over time, such as dates on which the tires are rotated, dates of alignments performed, and so on.

In one embodiment, RFID readers embedded within, on or alongside a road read the encoded information from the RFID members that are within the car tires.

Application No. 39: RFID Keyrings or Other Objects With Information About the Model of Automobile for Finding Car Parts at Car Parts Stores Without Having to Look at Catalogues

A problem often encountered by shoppers at car parts stores is that define the proper part for their car, they must look through of variety of different catalogs in order to match the make and model and year of the car, as well as perhaps other information, to find the part number of the proper part for their car. The process of going through many different catalogs can be exceptionally time-consuming and frustrating. Furthermore, sometimes catalogs are incomplete and do not have full information on all of the products that are available, and sometimes catalogs are missing entirely for particular brands auto parts.

In this invention, the user has a key ring on which is an RFID tag. The RFID tag includes information about the make model year and potentially other specific information about the car, such as particular options that it may have. If instead of using a printed catalog, the user is canvas the RFID tag across an RFID reader. A display is used in conjunction with the RFID reader and it may ask the user a series one or more questions, such as what type of parts the user's looking for. If the display is connected to a computer system that has a database, that can lookup appropriate car parts for the user's particular car. The RFID readers and display units may be dedicated to a particular car part, such as car batteries or car headlights, or maybe a general-use type of terminal in which the user is able to pick out any of variety of different car parts that are appropriate for his or her vehicle.

Application No. 40: RFID Cards Supplied With Newspapers or Magazines in Conjunction With Consumer Discounts, etc.

It is common practice to include a large number of consumer discount coupons in newspapers, particularly Sunday newspapers. The coupons are also provided in magazines, and in mailers that come in the form of magazines or newspapers to the user's mailbox. The coupons are also sometimes provided within a store, such as by a dispenser, or may be mailed in packages of coupon sheets or cards to homes and businesses.

In this invention, an RFID card is provided with a newspaper or magazine or other vehicle for distributing consumer coupons. The card may be active, semi-active or passive, but in most embodiments will be a simple passive RFID card. One embodiment of such a card is made of cardstock, with a thin RFID label adhered thereon. The label may be printed with graphics, text, or other indicia as appropriate.

In the case of the newspaper, the newspaper may still include descriptions of all of the products that discounts are available for. The newspaper may even include clippable coupons that may be used in the traditional manner at the checkout counter of the supermarket or other store. However, the newspaper also provides an RFID card that contains information about the discounts on the same products.

As described above, in one embodiment, an RFID coupon is a simple cardboard card having RFID label. On the RFID label is encoded information about one or more of the discounts being offered. When the user goes to the store, rather than bringing a physically clipped coupon in order to obtain the discount, the user brings the RFID card. The checkout person or other mechanism at checkout reads the card with an RFID reader, and the discount is applied through the computerized checkout system.

In another embodiment, all of the discounts available through coupons within the Sunday paper are encoded in digital form on the RFID card that is provided with the newspaper. That way, the user does not need to clip individual coupons, but can simply provide the checkout person or other mechanism within the store with the RFID card provided in newspaper. Any of the discounts that apply to items that the consumer is purchasing at the store are automatically given. The RFID card saves the user the trouble of having to clip physical coupons in order to obtain the advertised discount.

And more broadly, the invention encompasses providing information on the RFID card, or chip, or tag, or other RFID module that allows the consumer to get a discount on one or more products when checking out at the supermarket or other store. Typically, there will be an RFID reader at the checkout stand to read the RFID object to determine what discounts are to be given and to what products. This approach also saves the supermarket a great deal of money, in that it does not need to send physical paper coupons to an external site to be authenticated, nor does a complex financial system need to be in place in order to provide credit to the store for the physical coupon.

The RFID card “coupons” need not be distributed in the newspaper, but may be distributed in magazines, in mailed envelopes, and or in any of the current modes in which coupons are dispensed.

Another embodiment of the invention is a clippable coupon on which an RFID label has been applied, or onto which an RFID circuit and antenna has been printed. Methods of printing RFID circuitry and antennae are known in the art. In this embodiment, the user must still take the coupon physically to the store or other location, but the information that is scanned by the store or other location is provided in digital form on the RFID chip. The RFID coupon may include information about the user's address, ZIP code, the location of the source of the coupon (such as in the newspaper, or in a mailing, or in some other location) and/or information about the product, or any of a variety of other information. Some of this information may be of the type that cannot normally be provided on a paper coupon.

Even more broadly, the invention encompasses the idea of including an RFID card, or RFID label, or RFID chip, or printed RFID circuit, or other RFID object in conjunction with the newspaper or magazine or periodical or special publication that is delivered to the user's home or business.

Application No. 41: An RFID Card That Lights Up a When the User Reaches a Particular Point in the Room, Such as the Correct Table for Dinner

In this invention, the user has an RFID chip, or card, or bracelet, or implant, or other RFID device, such as a label applied to a ticket or label. The RFID device is typically passive but may alternatively be active or semi-active. As a user walks through a room, such as a dining room, and reaches a particular location to which that person is to correlate, such as a particular seat at a particular table for dinner, a light or other indicator is activated.

One or more RFID readers is provided in the room at one or more strategic locations. The RFID reader reads information from the RFID device. The information is sent to a centralized computer system, which is in communication with various indicators in the room at tables and/or seats and/or other locations that attendees may be looking for.

So for example at a wedding, a guest may know generally where to go, but not the exact table or seat. When the user approaches the appropriate table, a light may go on, or a gentle sound, or other the audiovisual or other indicator that is activated. When the user nears the table, another light may go or other indicator may be activated at his or her assigned seat.

This may be extended to applications, such as in a stadium when the user reaches the proper row where his or her seat is located. Furthermore, as an option, when the user nears the proper seat, an indicator may sound, or some other indicator may go on, such as a light alongside the seat, to indicate that the user has reached the proper location. There are many, many other potential applications for technology such as this, such as for use in dark venues where finding the proper location can be difficult, or for use by the handicapped who need extra indication (by way of sound or light or other means) of where they are supposed to go.

Application No. 42: RFID Label on a Sports Ticket, Automatic Map Generation to Seat After Ticket is Read

In this application, a sports ticket is provided with RFID. The ticket may simply include an RFID label, which is adhered to the ticket. The RFID label may appear, in one embodiment, to be an integral part of the ticket, with printed graphics, text and/or other printed matter to make the label blend in with the appearance of the rest of the ticket.

Alternatively, the RFID mechanism may be integrally built into the ticket. For example, an RFID sports ticket may have a lower layer of light card stock, with the RFID circuitry and antenna on top of the light card stock and possibly a layer of adhesive to hold the RFID circuitry in place, with a top layer of cardstock placed atop the RFID mechanism and adhered, glued or otherwise attached to the lower layer of cardstock.

Many other constructions are possible, including printing the RFID circuit and antenna on a substrate, incorporating an RFID chip into the ticket and interconnecting it with an antenna (which may be printed onto the substrate). Another alternative is to microemboss (as is known in the art) a substrate and form an RFID circuit through fluidic self assembly and other methods developed and/or used by Alien Technology Corporation. The specific construction of the ticket is within the skill in the art.

Stored on the RFID label or other mechanism is information about the user's seat number and row number and section number, as well as potential other information, such as marketing information about the user him or herself, such as his/her age, how they purchased the ticket or whether it is a corporate-purchased ticket.

In one embodiment, the RFID encoded information may indicate that the user has a certain amount of concession credits, for use at concession stands and such. The RFID label may be rewritable, in which case further information can be encoded onto the label, such as the date, time and entry point into the event, or other useful information.

In one method of use, the user inserts the sports ticket into a ticket reader, which reads the information on the RFID label or other RFID mechanism. An optional display may then automatically display the location of the ticket holder's seat and section, and may optionally printout a map as to how to get there. The system may alternatively printout or display other information of interest to the user, such as information about the users favorite sports teams, sports scores, special discounts that are tailored to the user's particular profile, and/or other information.

In one approach, upon entry into the venue, the RFID reader that has read the ticket may send information to a central computer system for storage of the entry information into a database, to retrieve messages to give the entrant (messages which may have been sent by a group that the user is to meet, for example, or commercial messages about products and the like), or for other purposes.

Application No. 43: RFID Card That Tells a School Cafeteria When Lunch to Prepare for Particular Student

Students at a school have RFID cards, or tags, or chips, or RFID implants or another type of RFID device. When the student goes to the school cafeteria for a meal, an RFID reader reads information on the RFID memory. The information may include information about the students' dietary preferences, or may simply be a student identification number. The RFID reader that reads the RFID memory may be interconnected with a computer system, which when the users student identification number is input may check a database for dietary preferences and vrequirements for that particular student. A monitor or other display device may then be provided so the cafeteria workers can customize the student meal to that particular student. The RFID reader may also be interconnected with a computerized accounting system, which automatically deducts the cost of the lunch from the students account, or otherwise charges the student for the cost of the lunch. Information may be written to the RFID device, such as what the student purchased for lunch, if the RFID device is rewritable.

Application No. 44: Student Desk With Slot to Receive RFID Card, Desks on Networks Together, Central Computing System Can Tell Where Any Particular Student is Sitting at Any Given Moment Within the School

In this invention, desks in classrooms are provided with slots to receive RFID cards that students carry. The desks are networked together and report to a central computing system. When a particular student is sitting at a particular desk, the student inserts the RFID card into the slot. The central computing system then knows the exact location of each student when thee sitting at a particular desk.

This may be useful in test taking, for example, or for locating a particular student during an emergency or other critical time.

As an alternative, there may be a simple RFID reader provided at the desk, over which the user slides his or her RFID card to be read, or which otherwise reads the information on the student's RFID device and/or writes information to the student's RFID device.

As further alternatives, the user/students may have RFID wristbands, chips, implants or other RFID devices. Typically the information stored on the RFID device will be the student's identification number, from which the centralized computer system can cull various data from a student database. However, the RFID memory may also include other information, if desired.

Information written to the RFID device may include homework and quiz and test grades, attendance data, and other data written cumulatively over time.

Application No. 45: RFID Readers on Outdoor Play Equipment, Students With RFID Tanks or Cards or Chips Embedded Within Them, Centralized Computing System That Can Tell Where the Particular Kid is on the Playground at any Given Moment

In this invention, RFID readers are provided on an outdoor playground. Children are provided with bracelets, RFID cards, or other RFID devices, such as implants, which can be read by the RFID readers. As the children pass various areas of the playground, the RFID chips are read by the RFID readers. The RFID readers may be networked together and communicate to a centralize computer system. There may be a display at some point in the playground, so that a teacher or supervisor looking for particular child may see the location of the child on the display. The display may be set up such that all children on the playground are shown simultaneously on a map.

Alternatively, the display may provide a menu from which the parent or other guardian selects the name of the child or other ID associated with the child in order to find the child on the playground. In one embodiment, the RFID device is provided in the form of a bracelet band that is locked about the child's wrist. That way the child cannot remove the RFID band as he or she moves throughout the playground.

The RFID locking band may be combined with the GPS is mechanism, which allows the parent or guardian to find the child even outside the playground, as for example when the child has wandered away entirely from the playground. The centralized computer system may contain a database that stores information about the identity and locations of children as they move throughout the playground over a period of time. In this way, and in one application, the managers of the playground can determine which equipment is getting the highest use and which equipment is getting less use, and may gain other information to then managing and/or of the changing the playground.

Application No. 46: Authentication of Expensive Items With RFID

(Add use of codes, unique serial numbers, etc.)

In this invention, expensive jewelry items such house is expensive pens, and are provided with the RFID label in the hidden location. For example, in the case of a fountain pen, an RFID label is inserted into the interior of the pen. The RFID chip is encoded with the serial number of the pen and/or other information, such as the name of the owner and contact information if the pen is found. As of this RFID labeling also helps to authenticate the pen, as there is a large black market in fake expensive pens. In the same principle may be applied to other forms of expensive items, such as cigarette lighters, and certain types of bracelets, various forms of jewelry, etc.

And in one embodiment, a bracelet or necklace is of the woven medal type. Woven into the medal and fairly undetectable, for example at towards the back of the necklace near the clasp or at another inconspicuous area, and RFID mechanism, including antenna, is woven into the jewelry. The RFID mechanism and antenna may be painted or otherwise disguised so as to be entirely unnoticeable to the typical onlooker. However the RFID chip provides identification information for the jewelry, such as a serial number, a manufacturer name, C. owners name and contact information, and/or other information that may be useful.

Application No. 47: Paintings or Other Art Work With RFID Label to be Used to Verify the Number in a Limited Series

Many artists produce limited number of lithographs in a limited editions series. Each lithograph in the series is signed by the artist, typically, and is numbered in terms of which number in the series the particular lithographs is. For example, the 54th lithograph in a series of 100 may be represented as 54/100 near the signature of the artist.

However, there is a large black market in inauthentic limited edition lithographs. To add an added measure of authentication to limited edition lithographs and other limited edition artwork, an RFID label is applied to the back of the lithograph. The information on the RFID tag is encoded with the information such as the name of the lithograph, the total number of lithographs in the series, the particular lithographs within the series that this particular lithographs is, the artists named, and/or other information. By using a very thin RFID label, as is known in the art, the authenticity of limited edition lithographs and other artworks, which may include limited edition clay works, limited edition sculptures, and any other type of limited edition may be established.

Application No. 48: RFID on Football Helmet, Recognizes Player Running Out of Tunnel, Informs Announcer and Others

In this embodiment, an RFID label is applied to the interior (preferably) or exterior of the football or other type of sports helmet (such as motorcycle or bicycle helmet). The RFID chip is programmed with information such as the identification number of the player, and/or other information. In one application, an RFID reader is placed in or adjacent to the tunnel through which sports players exit as they enter a sports playing field. The RFID reader reads the RFID information on the top of the user's helmet, which may then be transmitted to a central computer or reporting system. This may aid announcers and other officials in identifying the players as they enter the field.

As a further alternative, RFID readers may be placed strategically around and/or on the sports field and/or stadium so that the location of particular players may be known at any given time. The players may have passive RFID tags as part of their clothing (such as being sewn into their uniform).

Furthermore, RFID readers can be embedded within the turf. The RFID readers, wherever they may be placed, may be networked together and/or may all report to a central computer system so as to report the location of each player on the field at any given moment. This may also aid in knowing where a particular spot is located where a player has been tackled, etc.

As yet another embodiment, an RFID label or other RFID device may be included in the sports ball, such as on the interior of a football or a soccer ball, or woven into the fuzz of a tennis ball, with RFID readers underneath the turf or adjacent the court or otherwise optimally positioned. In this way the exact location of the ball may be followed as a game is in progress.

It may be noted that this invention may be altered by, for example, using labels that incorporate both RFID and GPS technology, so that the RFID information may be used in conjunction with the GPS location information. The RFID information may include information about the player and/or the player's playing history and/or other information. If the RFID tag is rewritable, information may be written to the tag as the game progresses as, for example, to maintain a history of the player's position.

Application No. 49: RFID Alien Chips in Paint

Alien technology Corp. specializes in making very small RFID chips. Alien also produces very small RFID tags, using very small RFID antennas. In this embodiment, as RFID tags of the type produced by Alien are mixed into paint. A user may mix the paint such that the RFID chips are distributed evenly within the paint, and then paint an object such as a wall.

The paint holds the RFID chips onto the wall. Typically, a thick latex paint or other thick paint may be used. A second coat of paint that does not contain RFID chips may then be painted over the coat of paint containing the RFID chips. The RFID writer may then be used to encode information onto the chips, or the chips may be pre-encoded with information prior to being mixed into the paint. In this way, an ordinary wall may become an information bearing wall, from which information can be read by an RFID reader.

In another embodiment, RFID labels are adhered to walls prior to painting. After the RFID labels are adhered to the walls, one or more layers of paint are painted over the RFID labels so that they are not visually detectable. Someone with a RFID reader may then scan the wall and the information from the RFID labels that are on the wall. If the labels are of the rewritable variety, information may be added or changed on the labels from time-to-time. In one embodiment, an RFID writer is located in the room to write information to the tags. In another embodiment, an worker with an RFID writer moves the writer along the wall to change information on the RFID tags on the wall.

In yet another embodiment, RFID tags or other RFID devices other than labels are embedded in the wall, such as within the plaster in plasterboard, such that information on the RFID devices may be read by an RFID reader. The RFID devices may even take the form of nails in which are embedded RFID chips and, the nails serving either a structural purpose in holding members together, or simply being embedded within the wall or within studs or other wooden members associated with the wall.

In another embodiment, tiny RFID tags are embedded in paint, which is then painted onto an automobile. It is noted that PENI tags or other tiny tags are best suited for incorporation into paint. Other suitable tags may be made by Alien Technology Corporation, which currently sells a tiny tag made with Fluidic Self Assembly technology, as described in Alien's patents and literature.

Application No. 50: RFID Cards Issued to Airline Passengers so That Flight Attendants Lnow What Type of Drinks, Meals, and Other Amenities to Bring a Particular Passenger, etc.

In this application, airline passengers are provided with an RFID card, or chip, or having RFID implant, or other RFID device. In one embodiment, after the passenger has cleared security, or at another point that is convenient in the airline check-in process, each passenger is provided with a bracelet having RFID circuitry and an antenna. The bracelet may be made to be unremovable from the passengers wrist, without cutting it off. Disposable bracelets of this type are well known in the art, although not with RFID circuitry and an antenna embedded therein.

Irrespective of the form of the RFID device, the RFID chip is embedded with information about the passenger. The information may be as simple as an identification number identifying the passenger. The information may be extended to include such items as the passenger's name, nickname, food preferences, and other desired information. Security information may also be encoded, as well as ticket information. If the RFID chip is rewritable, information may be written to the RFID chip at various locations in the airport, such as upon clearing security, upon boarding the aircraft, etc.

In one application, such bracelets (or other RFID devices) are used in the first-class section of an aircraft. As passengers board the aircraft, an RFID reader reads the RFID information stored on the bracelet or other RFID device. A centralized computer system within the aircraft records the information. If necessary, information from the RFID bracelets or other RFID device is correlated with passenger information stored within a database of the centralized computer, which is typically onboard the aircraft but may also be external to the aircraft. Alternatively, the memory on the RFID chip may be great enough so that no external database is necessary and all information that is to be used is encoded on the RFID chip.

The passengers may have, in advance of boarding the flight, chosen meal selections, chosen preflight drinks, and specified other amenities, such as what type of newspaper magazine the passenger wishes to read in flight. The passenger may also specify information, in some embodiments of the invention, such as softness of the seat, temperature of the seat during flight, whether the user wishes comfortable slippers for the flight, any special dietary requests, any information or requests that the passenger wants the service personnel to know, or other information pertinent and typical of first-class passengers.

The user might also have specified that they wished she have a down filled pillow rather than the polyester pillow, a special type of blanket, or the like. This information is then instantly available to flight attendants as the passengers board the craft.

RFID readers may be provided at or near the seats themselves. Alternatively, the flight attendants may carry hand-held RFID readers, so that the flight attendants can see, on a display that maybe on the device, for example, the passenger's name, and various preferences. The flight attendant is then able to serve the passengers in a most unobtrusive manner during the flight and with greater efficiency. The passengers are also provided with additional quiet time, as the flight attendants do not need to ask them so many questions as is currently customary during flight.

This concept can be extended to business class and coach passengers as well.

In one embodiment, the RFID mechanism worn or carried by the user (or sewn into their clothing or otherwise associated with the passenger) may be read by an RFID reader along the aisle or overhead as the user walks. When the user approaches the correct row and seat, a light at the row may light up to indicate the correct row of the passenger's seat, and/or a light at the seat itself may illuminate to indicate that the passenger is to be seated at that seat.

With RFID readers scanning the RFID information associated with the passengers, the flight attendants are able to know at any given moment the exact location of any particular passenger. So, for example, if the particular passenger has changed seats during flight with another passenger, that information may be made automatically known to the flight attendants. That is, the RFID reader or readers may be interconnected with a computer system onboard that is associated with memory and/or a database and displays to which the flight attendants may refer during flight.

Other information may be stored on RFID chip may include baggage claim information, such that when the user goes to claim baggage, information embedded on the chip confirms that particular baggage belongs to the particular person. Many other uses for the RFID chip may be imagined. In the example of the nonremovable RFID bracelets, the structure of a bracelet may simply be a polymer outer layer with an RFID tag or label on the interior. Alternatively, an RFID label may simply be applied to the outer surface of the bracelet, preferably with a permanent adhesive so that the RFID label cannot be removed.

A special locking clasp or other non-breakable securing mechanism is provided so that once the user has removed the bracelet, the bracelet cannot be reattached to the user's wrist. These are known in the art. Also, it is desirable to make it difficult for the user to remove the bracelets in the first place, such as by using materials that are difficult to remove without cutting with sharp scissors or a knife.

Numerous applications in the area of security may be imagined for such a bracelets, such as in control of passengers at immigration, control of passengers moving between connecting flights, added security at security checkpoints, added verification that the user is indeed the person affiliated with the ticket with which the person is holding, and so forth. Further information may be encoded on the RFID chip to replace the ticket, such that passengers do not need to carry tickets and boarding passes, but may simply carry the RFID devices, such as wearing the removable bracelets, and the RFID information embedded thereon serves to allow the wearer access to the proper gate and planes.

As discussed previously, the information on the RFID chip may be as simple as a user identification number, with RFID readers being networked together with a centralized computer system having a database that compares the user ID number with various information about the passenger. That information may include a photograph of the passenger, so that upon being read by an RFID reader, the user's photograph appears on a screen so that a security person may verify that the wearer is indeed the proper passenger. Many similar applications may be imagined.

Application 51: Greeting Cards With RFID

A greeting card is supplied with an RFID device, most preferably an RFID label, onto which is coded information in addition to printed or written information on the card. The RFID label may be encoded with information which, when read by a scanner, causes a display to display a website, to play a song, to display a personal message, or any of a vast number of applications. Typically, the RFID label will be placed on the interior of the card, and may be in the form of a heart or other shape appropriate for the occasion of the card.

The concept may be extended to business cards, onto which an RFID label may be applied, or the business card may be constructed with upper and lower sheet members, with the RFID components sandwiched in between. The upper and lower sheet members may be held together by, for example, glue or a permanent adhesive. When an RFID label is used, the label may take a decorative shape, so as to aesthetically complement the text on the business card. The information on the RFID label may take the user to a website when scanned with appropriate equipment, or provide the user with access to a special event sponsored by the company, or any of a myriad of other applications.

In another embodiment, the RFID chip and antenna is printed onto the business card, using technology now known in the art. In another embodiment, the RFID chip is very tiny (such as a PENI or other tiny RFID chip) and is placed on the card so as to appear part of the design of the card. With RFID chips that require an external antenna, for example, the antenna may be shaped so as to outline some graphic on the card, and not appear to be an antenna, but rather to be part of the aesthetics of the card.

Application 52: Decorative Tiles With RFID Tags

Decorative tiles, such as tiles that go on kitchen counter tops, on walls, in showers or bathtubs, and so on, are provided with RFID tags. In one embodiment, a recess is provided in the back of the tile into which an RFID tag may be inserted. The recess may extend most of the way through the tile, so that the RFID tag is just underneath the surface of the tile and can be easily read by an RFID reader. If there is remaining space within the recess after the RFID tag has been inserted, the space may be filled with grout, an adhesive, or other filler that will help retain the RFID chip in place.

Application 53: Car Washes

A typical carwash has a digital control system that controls key aspects of the carwash, and operates the various stations within the carwash, such as the pre-wash, the foamer, the brushes (if any), the waxer, the dryer, and/or other stations in a car wash. A description of a current carwash system is available as of the time of this patent application filing beginning at http://auto.howstuffworks.com/car-wash.htm, which is incorporated by reference.

As background information, car washes are normally either touchless or cloth friction wash. A touchless car wash relies on high-powered jets of water and strong detergents to clean the car. Only the water and cleaning solutions actually come in physical contact with the car.

Cloth friction wash systems use soft cloth that is moved around against the surface of the car. The system that we will discuss uses cloth friction wash technology, but quite a few of the same components are used in touchless car washes.

First, the car is placed on the conveyor track. At the beginning of the conveyor is a device called a correlator. This is simply a series of wheels or rollers that allow the wheel of the car to slide sideways until it is aligned with the conveyor. The correlator in this system is a set of long rollers.

The car is turned off and placed in neutral. Most conveyor systems have small rollers that pop up behind the wheel once it is on the conveyor. The roller pushes the wheel forward, causing the car to roll along through the tunnel, which is the term used to describe the long bay used for exterior-only and full-service systems. There are two standard types of conveyor systems:

Once the car enters the tunnel, it passes through an infrared beam between two sensors, called eyes. The eye on one side emits infrared light that is picked up by the eye on the other side. As soon as the beam is interrupted, the eyes send a signal to the digital control system (DCS), the computer that runs the automated portion of the car wash. By measuring the amount of time that the signal is interrupted, the DCS determines the length of the vehicle and adjusts the system accordingly.

Soap Up

Immediately after the eyes, most car washes have a pre-soak. This is an arch that contains several small nozzles that spray a special solution all over the car. This solution does a couple of things:

Wets the car down before the application of any detergents

Contains chemicals that begin loosening the dirt on the car

A lot of car washes also have a set of nozzles arranged near the ground that are called tire applicators. These nozzles spray the tires with a solution designed specifically for removing brake dust and brightening the black rubber of the tire.

In one car wash, the car then passes through a mitter curtain. This is a series of long, soft strips of cloth that hang from a frame near the top of the tunnel. The frame is connected to a motorized shaft that moves the frame up and down in a circular pattern. This makes the cloth strips rub back and forth across the horizontal surfaces of the car.

The mitter curtain cleans the hood, roof and trunk of the car by swishing back and forth over the surface.

The next item is the foam applicator. The foam applicator applies a detergent to the car that becomes a deep-cleaning foam on contact. The nozzles on the foam applicator, as well as most other spray systems in a car wash, can be adjusted to change the angle of the spray and the size of the opening. The foam is created by mixing a chemical cleaner, which varies between car washes, with water and air. There are usually separate adjustment controls for determining the exact mix of the three components. The chemical typically contains some coloring agent to make the foam more eye-pleasing and obvious.

Scrubbers are large vertical cylinders with hundreds of small cloth strips attached to them. The scrubbers rotate rapidly, anywhere from 100 to 500 rpm, spinning the cloth strips until they are perpendicular to the cylinder. Although the cloth strips are quite soft, it would feel like a whip if you got hit by them. Scrubbers normally have hydraulic motors that spin them. There is at least one scrubber on each side, and there may be two or more. As the car moves past the scrubbers, the cloth strips brush along the vertical surfaces of the car. Most car washes have multiple pairs of scrubbers.

Some car washes also have wrap-around washers. These are scrubbers on short booms that can move around to the front and rear of the vehicle, scrubbing those vertical surfaces as well. Like most of the mechanical equipment in the car wash, the washers are run by a combination of electric motors and hydraulics. Normally, a single, large hydraulic power unit is connected to all of the various hydraulic pumps throughout the car wash. Wrap-around washers clean the front and back of the car.

The cloth used in the scrubbers is very soft and regularly cleaned to ensure that there is nothing caught up in them that could scratch the cars. They are replaced once they become worn or too soiled to clean effectively. The scrubbers remove the dirt that the foam and pre-soak has loosened up.

In addition to the mitter curtain and scrubbers, a lot of car washes have a high-pressure washer. The high-pressure washer is a system of rotating water jets that spray concentrated streams of water onto the car. The nozzles of each water jet are typically arranged like a pinwheel, with each nozzle angled slightly away from the center.

The nozzles of the water jet are reminiscent of a pinwheel. The force of the water shooting from the nozzles causes the water jet to spin rapidly. This means that the stream of water moves in a circular pattern as it hits the car. The strength of the stream and the circular motion combine to provide a powerful scrubbing action on the surface of the car. The force of the water is incredible, with some systems rated at 1,000 pounds per square inch (psi). The powerful water jets remove most of the detergent and grime from the car.

High-pressure systems use a lot of water—perhaps 300 to 400 gallons (1,100 to 1,500 liters) per car. In order to provide so much water in a rapid manner, a car wash usually has a special pressure tank nearby that holds the water for this specific system. In most systems, almost all of the water is recaptured and recycled back to the pressure tank after each use.

A lot of car washes, particularly those in areas where winter means lots of snow, have a device called an undercarriage wash applicator. This system is located at ground level and has several nozzles pointed upward to wash dirt, mud and salt from the bottom of the car.

Next, the car goes through a rinse arch. This is a series of nozzles arranged on an arch that use clean water to remove whatever residue is left after the high-pressure washer, scrubbers and mitter curtain have done their respective jobs.

The rinse arch removes almost all of the residue left from the cleaning systems. In an average car wash, there are multiple rinse arches, usually after each major cleaning station. A typical car wash may have the following stations:

Pre-soak

Mitter curtain

Rinse arch

Foam applicator

Scrubbers

High-pressure washer

Undercarriage wash applicator

Rinse arch

Wax applicator

Mitter curtain

Scrubbers

Rinse arch

Dryer

As you can see, the example above has three rinse arches. It also has two mitter curtains and two sets of scrubbers, which is also common in most installations. In fact, some car washes have even more of each type of station. Most car washes have two or more mitter curtains along the tunnel.

The last rinse arch in the tunnel, aptly called the final rinse, should always use clean, non-recycled water to ensure that all residue is removed from the surface of the car.

The majority of car washes also provide some type of protectant that can be applied to the car.

Wax

A standard feature of the car wash is the wax arch. The wax that is used in a car wash, which forms a water-resistant coating, is quite different from the wax you would apply by hand. One of the key differences is that car-wash wax is formulated to work on glass, chrome and rubber, as well as the painted plastic and metal surfaces of the car. Also, it leaves a clear, thin film that does not have to be polished first. However, car-wash wax does not provide the same level of protection, nor help to remove or cover up tiny scratches, as standard wax does. Each wax protectant may have a different color of foam.

The wax arch uses one of two methods to apply wax. The first type of wax arch uses a system of foam applicators, the most common being a triple-foam applicator, to apply a foam wax. The wax foam is applied to the car in a heavy coating.

The second type uses nozzles, similar to those of the rinse arch, to apply a liquid wax. In this case, the next step is usually to go through a rinse arch. But when wax foam has been applied, the car usually goes through another set of scrubbers and another mitter curtain before going through a rinse arch.

Dry

After the car is completely washed, the final step in the automated process is the dryer. Much like a giant hair dryer, the dryer in a car wash heats large amounts of air and forces it out through a series of nozzles. These heated blasts of air rapidly dry the surface of the car.

The dryer has a large, flat, round section just before the nozzle opening. This section is called the silencer. Like a muffler or the silencer on a gun, the dryer's silencer deadens the noise created by the air being forced through the system.

A dryer in a full-service car wash does not completely dry the car because attendants will go over the car with towels once it leaves the tunnel.

Some car washes apply a special chemical after the final rinse, before the dryer, that speeds up the drying process. The temperature and force of the dryer can be set. Most full-service car washes set the dryer lower than exterior-only car washes. This is because a full-service car wash usually has attendants who hand-dry the car with towels to remove all of the water.

Touch Up

As the car comes out of the tunnel, it is pushed off of the conveyor track. In an exterior-only system, you most likely remain in the car. When it comes out of the tunnel, you put it in park, start the engine and leave. In a full-service car wash, an attendant drives the car over to the finishing station. Here, attendants clean the interior of the car, removing trash and vacuuming. They usually clean the windows, wipe down the dashboard and doors, add some air freshener and hand-dry the exterior. They may also clean and polish the wheels and polish any chrome, depending on the service options available.

The vacuum system at a car wash is a lot different from your typical home vacuum. It normally has a large central vacuum with multiple hoses connected to it. The hoses are usually either stretched overhead to each vacuuming station or buried underground. The air pump on this vacuum is very powerful, which is necessary to support all the hoses and handle the distance that each hose must cover.

The Controls

All of the equipment in an automated car wash requires a heavy-duty power source. Each station has its own fuse-protected circuit. Most car washes are designed so that the car wash can continue to operate even if one of the stations completely fails.

The digital control system (DCS) is the brains of the car wash. From the moment that the eye tells the DCS that a car has entered the system, the DCS controls every aspect of the car wash. It knows exactly where the car is at all times and turns on the appropriate stations as they are needed.

As noted above, there are many potential variables in a car wash, depending on the type of car and type of paint to be washed. For example, different types and concentrations of soap may be used, different types and amounts of waxes, different water pressures, speed of brushes or flaps or whatever physically rubs or washes the car, drying times and temperatures, and so on. Some variations have not yet been widely used, such as using colored or tinted waxes or other coatings to highlight or enhance the color of the paint.

In this application, a car has an RFID tag or label, such as a label applied to the windshield, a waterproof label that serves as proof of registration renewal on the license plate, a tag attached to the interior of the car, a tag inside or outside a tire, on the wheel, or anywhere else on the car where an RFID tag or label can be read. The tag or label is typically a passive tag or label, but may alternatively be active or semi-active.

The tag or label on the car is encoded with information about the car, which may include one or more of the following: make, model, year, specific color, one or more dimensions of the car, date of last wash, whether the car is kept indoors or outdoors, whether the car is typically driven in dirty environments, the vehicle identification number, the license plate number, and/or various other information. The tag or label may even be encoded with special car wash instructions, either from the automobile manufacturer, the paint or wax or clear coat or other manufacturer, a paint shop that has repainted the car, a carwash, or any other source. If the tag is rewritable, the car wash may write information onto the RFID tag as to dates of car washes, specific services performed, and so on.

The carwash may provide the tag or label, or the tag or label may be part of the car already.

In one embodiment, an RFID reader reads the information on the tag or label. Based upon the information, a computer-controlled carwash system may vary certain carwash variables, such as type of soap, type of wax, washing type of wash, and so on. For example, a new sports car with a brand new, clear coat paint finish may receive a special soap appropriate for new, clear coat paint. As another example, an older car that has not been washed for a long time may receive an extra strong soap and a longer wash time.

In one embodiment, a computer system has a database to correlate information read from the RFID tag to particular preferred carwash variables. The database may be constructed using manufacturer recommendations from car companies and/or companies that manufacture or supply carwash supplies, empirical experience of the carwash itself with different makes, models and paint types, or other sources. The computer system may search the data base using some or all of the information read from the RFID tag, and arrive at an optimal set of carwash settings, such as using a particular type or amount of soap, using a particular type or amount of wax or other coating, using a single wash cycle or a double wash cycle, using a special colored coating to enhance the color of the car, or so forth.

The RFID tag or label is typically read before the car enters the carwash, so that the settings can be made before the wash begins. As an alternative, the RFID information may be read during the wash, or several times during the wash at different locations, as desired.

In one embodiment, after the car has moved through the car wash and is ready for hand-done tasks such as applying armor all, cleaning the windows, etc., workers are provided with a hand-held RFID reader that reads information from the RFID tag or label. The worker then uses that information to determine which type of chemicals to use on the car and to be informed of any special instructions from the car. Alternatively, the particular class of carwash (e.g. a “super” wash, a “basic” wash or so on) may be encoded on the RFID tag or label at the time of car wash purchase, so the worker knows what services to perform.

As a further alternative, rather than using hand-held RFID devices, a display or a set of displays is provided for the workers from which they can read special instructions or other information sent by a central computer system.

It is noted that U.S. Pat. Nos. 6,343,241 and 6,338,008 mention ordering and paying for car washes using RFID devices, and both of those patents are incorporated by reference herein.

As used herein, “RFID device” means a tag, label, fob, RFID keyring, or any other RFID device on which readable information is stored.

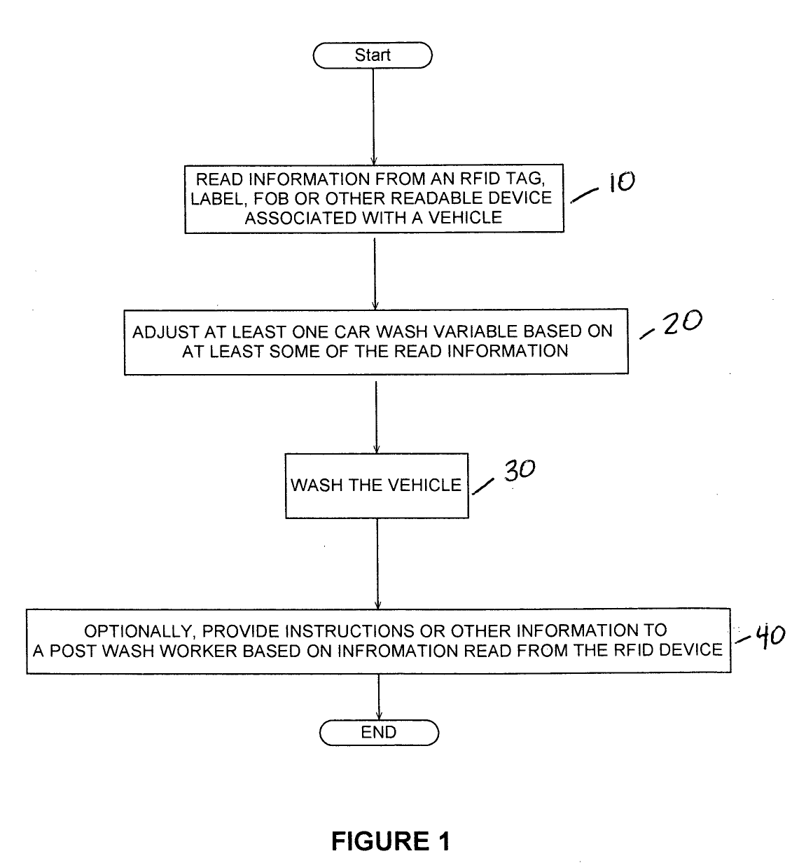

Turning now to the drawings, FIG. 1 is a flow diagram of one embodiment of the invention. At step 10, an RFID reader reads information from a tag, label, fob or other RFID device associated with a vehicle. At step 20, car wash variables are adjusted based on at least some of the read information. At step 30, the vehicle is washed, with the car wash implementing the car wash variables that have been adjusted. At step 40, a post-wash worker is optionally provided with instructions or other information based on information read from the RFID device.

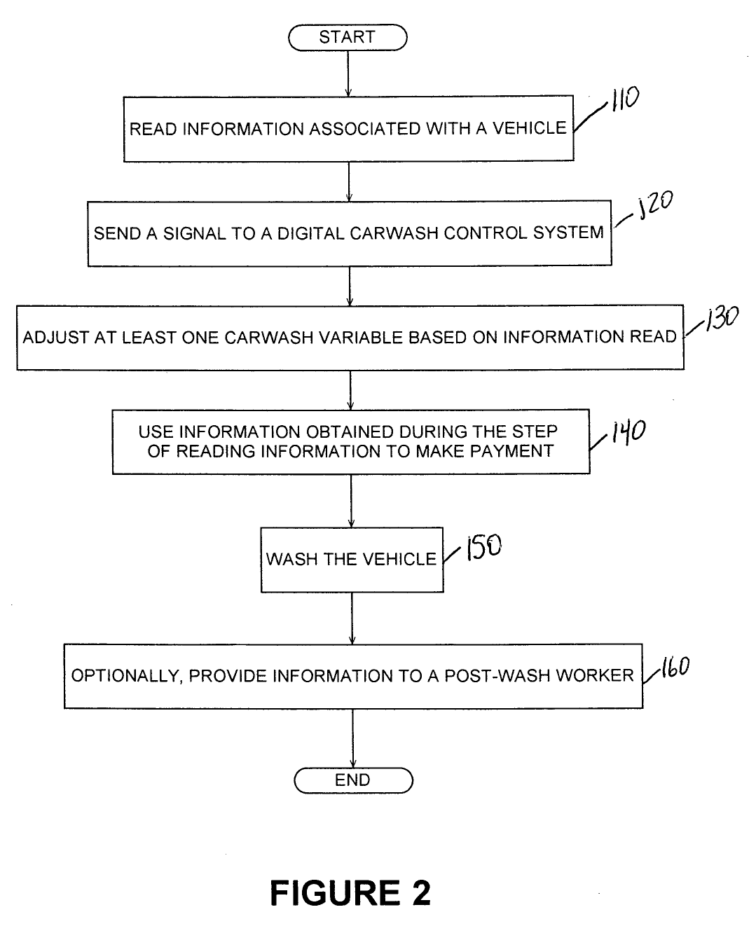

Considering an embodiment of FIG. 2, at step 110 information associated with a vehicle is read. A signal is then sent to a digital carwash control system, at step 120. At least one car wash variable is adjusted based upon information that has been read, at step 130. At step 140, at least some of the information obtained during the step of reading information is used in a payment process, to make payment. That information may be a credit card number, identification number, or other number associated with a particular account. Methods for making payment using RFID fobs, tags, labels and similar devices are known in the art.

The vehicle is washed at step 150. Optionally, at step 160, a post-wash worker is provided with information and/or instructions, such as what chemicals to use on the paint of the car, whether interior scent is to be applied, whether the tires are to be treated, and so forth.

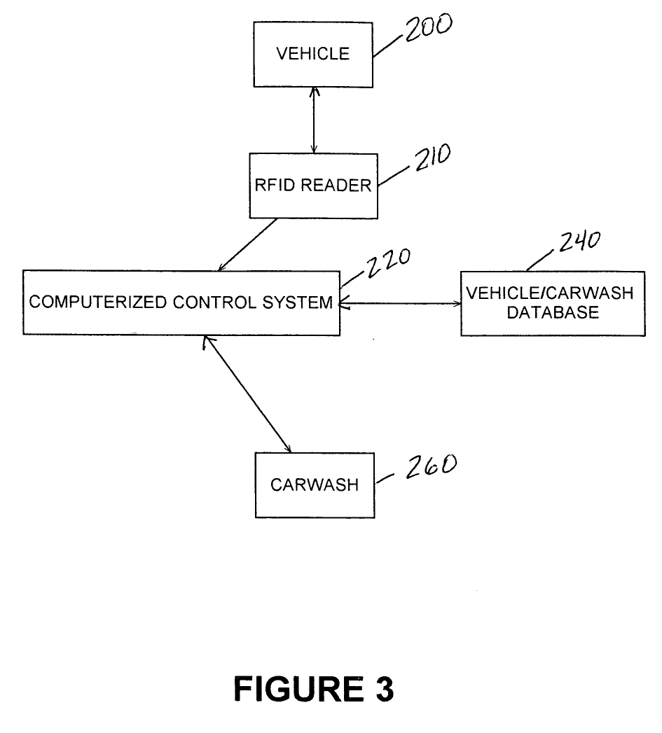

FIG. 3 illustrates components in one car wash system. An RFID tag, label, device, fob or the like is associated with vehicle 200. An RFID reader 210 reads the RFID device before the vehicle 200 enters the car wash (although it is possible to place the reader inside of the car wash). A computerized control system 220 receives information from the RFID reader 210, and processes that information. Some of the information may be in the form of codes, with which the control system consults a database 240 of vehicle and/or carwash information. For example, one code on the RFID device may identify the make and model of the vehicle. The database may include information about that vehicle, such as dimensions and parameters relating to the type of paint that is used on the vehicle. The computerized control system 220 makes use of information obtained from the database 240 to set carwash variables in the carwash 260, such as wash time, mix of chemicals to be used at various points in the wash, water pressure, and the like.

Other embodiments are quite possible within the scope of the invention.

Application 54: Adaptive Advertising

In this application, a stream of people travels along a path. Advertising is displayed along the path. The specific advertisements displayed are changed depending on charactistics of the stream that passes along or approaches the advertisement at a particular time.

As one example, automobile traffic flows along a highway. A large video display screen lines the road. Some distance upstream in the flow, one or more RFID readers read RFID information from the cars passing along the road. The automobiles include RFID tags or labels that can be read by RFID readers that are embedded in the road, or placed alongside the road, or suspended above the road, or otherwise situated so as to read the RFID information from the cars.

The RFID tags or labels on the cars may be passive, active or semi-active. The RFID tags or labels may be encoded with a variety of different information. The information may be limited, as for example to the make, model and year of the car. Or may include much broader information, such as marketing characteristics of the owner of the car and/or his or her family. Marketing characteristics may include any of a large number of variables, such as age, sex, ethnic background, family size, purchasing preferences and/or history, and so on. There is almost no limit to the marketing characteristics that may potentially be encoded on the RFID device.

The RFID readers read the information from the stream passing by the RFID readers, and transmits that information to a centralized computer system. The centralized computer system is provided with software to process the information from the RFID readers. The software correlates and analyzes the information, optionally using statistical analysis or other methods known in the marketing art.

Associated with the video screen are any of a number of advertisements. The advertisements are displayed based upon the analysis done by the centralized computer system. For example, perhaps the computer analysis determines that a group of automobiles that are approaching have marketing characteristics that make one particular advertisement more appropriate for that demographic group than the other advertisements in the group of advertisements. Then the computer system causes the video display to display the advertisement that the computer software has determined is most appropriate for the group of automobiles that is approaching.

As one of many possible examples, suppose that an analysis of the sampling of the RFID traffic flow data for some amount of time (say 3 minutes), reveals that occupants in that 3 minute traffic flow have a median age of 22 years and an income of less than 30 thousand dollars per year. The computer system may then choose to display an advertisement for blue jeans on the screen for the time period during which the sample group will be passing the display. The computer system would not, alternatively, choose to display an advertisement for expensive watches or luxury automobiles.

However, sampling RFID data from another group of automobiles, perhaps later in the day, may reveal that that particular group has a median income of over $200,000 per year. Then the analysis on the computer system may reveal that the optimal advertisement is one for a luxury automobile, or for expensive jewelry, or for an investment company. Consequently, the computer system causes the video display to display one such ad directed to the demographics of the traffic group that is approaching.

The RFID data may be as simple as the make, model and/or year of the automobiles. Appropriate advertisements may be selected from a group of possible advertisements based upon make, model and/or year information alone. Or, if more sophisticated RFID data is available, a more sophisticated analysis may be performed and advertisements more precisely tailored to the demographics of the appropriate traffic group may selected.

It is noted that in an alternative embodiment, the marketing data is collected from the cars by means other than RFID. As one of many examples, video cameras may be mounted along the road. The video cameras feed images into a computer system with software that can determine the make, model and/or year of the autos passing by the video cameras. Using this video recognition technology, data about the oncoming stream of cars is fed to the analysis software, which chooses an appropriate advertisement from among several possible advertisements based upon the characteristics of the autos that are approaching the video display.

As another alternative, the marketing data may be as simple as the speed of the flow of traffic. Presumably, those who are in stalled traffic may be in a mindset to view one type of ad, while those who are flowing freely in traffic may be receptive to another type of ad. Speed of traffic flow data is also useful data input to the computer system, to calculate at what time the advertisement should be changed for a particular segment of automobile traffic. Speed sensors leading up to the sign may send traffic flow data to the central computer system, in order to calculate when to change the advertisement to coincide with the arrival of the group of autos for which marketing data has been collected.

This concept is not limited to automobile traffic. It may be extended to flows of traffic of people on walkways, such as hallways in airports. In one example, airport pedestrians traveling along an indoor corridor carry RFID devices (such as RFID cards, RFID chips on bracelets, RFID chips sewn into clothing, or many other possibilities). One or more RFID readers read the data as the people walk by. Based upon the data gathered from the RFID readers, a computer system receiving information from the RFID readers employs marketing analysis software to decide which advertisement or advertisements should be shown to a particular group of pedestrians about to walk by one or more advertising boards.

It is noted that the invention is not limited to advertisements displayed on video displays. First, it is noted that there are several types of video displays that may be used, including TV-like video displays, displays that simply display text, and other video displays. Other types of displays that may be used include displays with rotating members that rotate in place to display different ads, and displays with banners and rollers that roll advertisements into place. Any type of advertising display that can display one ad chosen from among a plurality of ads upon command from a computer system may be employed.

Conclusion

It should be understood that foregoing ideas can be implemented with different forms of RFID implements: cards, bracelets, tags, labels, RFID sewn into clothing, braided into hair, shaped as utilitarian objects and so on. Consequently, the foregoing examples are generally not limited to one form of RFID device, but refers generally to whatever RFID device will work in a particular application. Generally, the RFID devices can be passive, active, or semi-active. One type may be more appropriate in a particular application than another, but most of the foregoing examples may be implemented with either an active, semi-active or active RFID device.

As used herein, “centralized computer system” can alternatively be a microcontroller or microprocessor, may be part of a network, may be a pc, may have a database, may have memory, or may be configured in some other way. Therefore, “centralized computer system” is a broad term encompassing many possible electronic configurations and is not limited to a particular system.

It is noted, for example, that readers may also be integrated into or added onto a laptop, a PDA device, a cell phone, or other electronic device. Suitable readers may include the readers of AWID or the RFID reader on a compact flash card marketed by Syscan International for reading 13.56 MHz ISO-compliant tags or for other frequencies, as described in the news item, “Get RFID Readers in a Flash (Card),” RFID Journal, Apr. 22, 2003, available online for subscribers at http://www.rfidjournal.com/article/articleview/393/1/1/.

Chip-based RFID systems need not be limited to silicon chips, but can also include printed electronics, particularly polymer electronics (organic electronics) such as organic field effect transistors (OFETs), and other technologies. Principles of polymer electronics are given by J. M. Shaw and P. F. Seidler, “Organic Electronics: Introduction,” IBM Journal of Research and Development, Vol. 45, No. 1, 2001 (http://www.research.ibm.com/journal/rd/45 /shaw.html). See also PCT publication WO 99/19883, published Apr. 22, 1999 by S. Babinec et al. of Dow Chemical.

A representative manufacturer of printed electronics technology is Precisia, LLC (Ann Arbor, Mich.), a business unit launched by Flint Ink (Ann Arbor, Mich.). Precisia, LLC produces printed electronics for RFID systems, including smart packaging, lighting, and displays. Conductive inks manufactured by Precisia, LLC including conductive particles of silver or carbon have been proposed for use in printed RFID antennas. Such inks can be applied by screen printing, flexographic printing, lithographic printing, gravure printing, ink-jet printing, and the like. Plastic Logic (Cambridge, England) is another firm producing printable electronics suitable for RFID applications.

Other components associated with RFID systems can also include polymer electronics or printed electronics. For example, display graphics can include organics LEDs (OLEDs), printed electroluminescent displays, printed organics application specific integrated circuits (organic ASICs), polymer thin film transistors (pTFTs), the light-emitting polymers (LEPs) of Dow Corporation (see www.lumation.com and Apply. Phys. Letters, Vol. 77, 2000, p. 406), and the like.

Power sources may include printed batteries, such as those produced by PowerPaper (Einat Israel—see www.PowerPaper.com) or Cymbet Corp. (Elk River, Minn.—see http://www.rfidjournal.com/article/view/94), or may rely on energy harvesting techniques that convert RF energy into useful electrical energy.

RFID tags can be assembled using flip chip technology, in which chips from an RFID wafer are inverted and placed in contact with an antenna. Exemplary processes include the Matrics PICA process for chip attachment to the antenna.

As can be imagined, many variations are possible to the foregoing examples. Consequently, the inventions of the present application are not limited to the specific embodiments described herein but include broader inventive concepts.

1. A method for washing a vehicle in a car wash, the vehicle or an occupant thereof having an RFID tag, label or device on which is stored information specific to that particular vehicle such as the make, model, year, paint color, type of paint, and/or other information, comprising the steps of:
reading stored data on the RFID device;
adjusting at least one car wash variable based on data stored on the RFID device to customize a wash for the particular vehicle; and
washing the vehicle in the car wash.

2. A method as in claim 1, wherein the at least one car wash variable includes at least one of the group consisting of amount of time in the pre-soak, chemicals used in pre-soak, time of wash, type of chemicals used in the wash, mix ratio of a chemical cleaner, amount of soap, amount of wax, type of wax, number of wash cycles, drying time, drying temperature, use of a chemical to enhance the color of the car, speed of the scrubbers, water jet pressure, rinse time, type of scent, and vacuum pressure.

3. A method as in claim 1, wherein the information on the RFID tag, label or device includes at least one of the group consisting of: make, model, year, color, at least one car dimension, wash history, date of last wash, conditions under which the car is driven, conditions under which the car is stored, vehicle identification number, license plate number, car wash instructions, car wash settings, paint type, tire size, payment information and coating type.

4. A method as in claim 1, wherein the step of adjusting car wash settings includes sending information to a digital control system.

5. A method as in claim 1, further comprising the step of providing instructions to a post-wash worker based on information read from the RFID device.

6. A method as in claim 1, wherein the method further comprises using information read from the RFID device to obtain further information from a data base.

7. A method as in claim 6, wherein the further information from a data base is used to adjust car wash settings.

8. A method as in claim 1, further comprising the step of reading payment information from the RFID device and processing that information to obtain payment for the car wash.

9. A method of washing a vehicle comprising:
reading RFID information associated with a vehicle with an RFID reader;
sending at least one signal to a digital carwash control system;
adjusting at least one carwash variable with the digital carwash control system based on information read in the step of reading RFID information;
using information obtained during the step of reading RFID information to make payment for washing the vehicle; and
washing the vehicle.

10. A method as in claim 9, wherein the at least one car wash variable includes at least one of the group consisting of amount of time in the pre-soak, chemicals used in pre-soak, time of wash, type of chemicals used in the wash, mix ratio of a chemical cleaner, amount of soap, amount of wax, type of wax, number of wash cycles, drying time, drying temperature, use of a chemical to enhance the color of the car, speed of the scrubbers, water jet pressure, rinse time, type of scent, and vacuum pressure.

11. A method as in claim 9, wherein the information on the RFID tag, label or device includes at least one of the group consisting of: make, model, year, color, at least one car dimension, wash history, date of last wash, conditions under which the car is driven, conditions under which the car is stored, vehicle identification number, license plate number, car wash instructions, car wash settings, paint type, tire size, payment information and coating type.

12. (canceled)

13. A method as in claim 9, further comprising the step of providing information to a post-wash worker based on information read from the RFID device.

14. A method as in claim 9, wherein the method further comprises using information read from the RFID device to obtain further information from a data base.

15. A method as in claim 14, wherein the further information from a data base is used to adjust car wash settings.

16. A method of washing a vehicle comprising reading information from an RFID device associated with the vehicle and adjusting at least one carwash variable relating to the manner in which the car is washed based on at least some of the RFID information.

17. A method as in claim 16, wherein the at least one car wash variable includes at least one of the group consisting of amount of time in the pre-soak, chemicals used in pre-soak, time of wash, type of chemicals used in the wash, mix ratio of a chemical cleaner, amount of soap, amount of wax, type of wax, number of wash cycles, drying time, drying temperature, use of a chemical to enhance the color of the car, speed of the scrubbers, water jet pressure, rinse time, type of scent, and vacuum pressure.

18. A method as in claim 16, wherein the information on the RFID device includes at least one of the group consisting of: make, model, year, color, at least one car dimension, wash history, date of last wash, conditions under which the car is driven, conditions under which the car is stored, vehicle identification number, license plate number, car wash instructions, car wash settings, paint type, tire size, payment information and coating type.

19. A method as in claim 16, further comprising the step of reading payment information from the RFID device and processing that information to obtain payment for the car wash.

20. A method as in claim 16, further comprising the step of using information read from the RFID device to obtain further information from a data base, wherein the further information from a data base is used to adjust car wash settings.
